(19) United States
(12) Patent Application Publication
(10) Pub. No.: US 2007/0224585 A1
(43) Pub. Date: Sep. 27, 2007

(54) User-managed learning strategies

(76) Inventors: Wolfgang Gerteis, Karlsruhe (DE); Wolfgang Theilmann, Karlsruhe (DE)

Correspondence Address: FISH & RICHARDSON, P.C., PO BOX 1022, MINNEAPOLIS, MN, 55440-1022, US

(21) Appl. No.: 11/374,497

(22) Filed: Mar. 13, 2006

(51) Int. Cl. G09B 3/00

(52) U.S. Cl. 434/350

(57) ABSTRACT

This disclosure generally describes systems, methods, and software involving user-managed learning strategies. One method for implementing a user-managed learning strategy comprises invoking a strategy template for a learning unit, with the strategy template comprising a plurality of strategy items and the learning unit represented by a plurality of learning items. At least a portion of a learning strategy is automatically identified based on the strategy template and the learning unit. The method further includes providing at least one navigation option to a learner, via a graphical user interface, based on the identified portion of the learning strategy.

### BACKGROUND

Today, an enterprise's potential in local or global markets at least partially depends on the knowledge and competencies of its employees, which may easily be considered a competitive factor for the enterprises (or other organizations). Shorter product life cycles and the speed with which the enterprise can react to changing market requirements are often important factors in competition and ones that underline the importance of being able to convey information on products and services to employees as swiftly as possible. Moreover, enterprise globalization and the resulting international competitive pressure are making rapid global knowledge transfer even more significant. Thus, enterprises are often faced with the challenge of lifelong learning to train a (perhaps globally) distributed workforce, update partners and suppliers about new products and developments, educate apprentices or new hires, or set up new markets. In other words, efficient and targeted learning is a challenge that learners, employees, and employers are equally faced with. But traditional classroom training typically ties up time and resources, takes employees away from their day-to-day tasks, and drives up expenses.

Electronic learning systems provide users with the ability to access course content directly from their computers, without the need for intermediaries such as teachers, tutors, and the like. Such learning systems may include or implement learning strategies that help—through didactic principles—guide these users when navigating through their learning material. Most traditional approaches involve one or more hand-coded algorithms for each strategy and are thus fixed.

### SUMMARY

This disclosure generally describes systems, methods, and software involving user-managed learning strategies. For example, one method for implementing a user-managed learning strategy comprises invoking a strategy template for a learning unit, with the strategy template comprising a plurality of strategy items and the learning unit represented by a plurality of learning items. At least a portion of a learning strategy is automatically identified based on the strategy template and the learning unit. The method further includes providing at least one navigation option to a learner, via a graphical user interface, based on the identified portion of the learning strategy.

In another example, one method for user management of learning strategies comprises receiving a manipulation of a strategy graphical element via a graphical user interface. The manipulation is then incorporated into a strategy template. Next, the method includes providing navigation support of a learning unit based on the strategy template.

The foregoing—as well as other disclosed—example methods may be computer implementable. Moreover some or all of these aspects may be further included in respective systems and software for testing other applications. The details of one or more embodiments are set forth in the accompanying drawings and the description below. Features, aspects, and advantages will be apparent from the description, drawings, and claims.

### DESCRIPTION OF DRAWINGS

FIG. 1 is a diagram illustrating an example learning environment according to one embodiment of the present disclosure;

FIG. 2 illustrates an example architecture of a learning management system implemented within the learning environment of FIG. 1;

FIG. 3 illustrates an example content aggregation model in the learning management system;

FIG. 4 is an example of one possible ontology of knowledge types used in the learning management system;

FIG. 5 illustrates one dataflow diagram of user-management of learning strategies using a graphical user interface (GUI) according to one embodiment of the present disclosure;

FIG. 6 is a flow chart illustrating an example method for assessing candidates for a learning strategy according to one embodiment of the present disclosure;

FIG. 7 is a flow chart illustrating an example method for determining transition candidates according to one embodiment of FIG. 6;

FIG. 8 is a flow chart illustrating an example method for identifying reachable strategy items according to one embodiment of FIG. 6;

FIG. 9 is a flow chart illustrating an example method for computing a deviation of a learning unit item order according to one embodiment of FIG. 6;

FIG. 10 is a flow chart illustrating an example method for providing navigation support based on user-managed learning strategies according to one embodiment of the present disclosure;

FIG. 11 is a flow chart illustrating an example method for deriving an automaton from a conditional regular expression according to one embodiment of the present disclosure; and

FIGS. 12A-C show example sections of a particular learning automaton and an associated strategy automaton according to one embodiment of the present disclosure.

### DETAILED DESCRIPTION

FIG. 1 illustrates an example environment 100 implementing a learning management system 140, which may deliver a blended learning solution of learning methods used in traditional classroom training, web-based training, and virtual classrooms. At a high level, such applications 140 provide convenient information on a learner 104's virtual workplace and at least partially control the learning process itself The system proposes learning units based on the learner 104's personal data, tracks progress through courses and coordinates the personalized learning experience. In addition, learning management system 140 encompasses the administrative side of the learning platform, where a training administrator 105 structures and updates the offering and distributes it among the target groups. Moreover, the course offering is usually not restricted to internally hosted content. The learning management system 140 often offers robust reporting capabilities, including ad hoc reporting and business intelligence. These capabilities may provide in-depth analysis of the entire business or organization, thereby enabling better decision making. Learning management system 140 also typically helps improve the quality of training and cut costs by reducing the travel and administrative costs associated with classroom training while delivering a consistent learning offering.

As described in more detail below, learner 104 may choose, design, or request one or more learning strategies to determine which path to take through the course. As a result, the progression of learners through the same course may differ. Learning management system 140 may implement user-managed learning strategies that make learning strategies easier to define and implement as well as easier for practical use. Specifically, learning management system 140 may use strategy templates that help define learning strategies in a generic way. In order to allow for generic algorithmic treatment of learning units and strategy templates, learning management system 140 may define or use formal representations for both. These representations help learning management system 140 to assess different navigation options within a learning unit according to a given strategy template. This assessment may then be used as a basis for an overall navigation support algorithm. Further, learning management system 140 may present a graphical representation for strategy templates and show how this representation can be mapped to the formal representation, thereby allowing for easier specification of strategy templates. Similarly, learning management system 140 may automatically map the graphical representation of the structure of learning units or the particular strategy to the respective formal representation.

Returning to the illustrated embodiment, environment 100 is typically a distributed client/server system that spans one or more networks such as external network 112 or internal network 114. In such embodiments, data may be communicated or stored in an encrypted format such as, for example, using the RSA, WEP, or DES encryption algorithms. But environment 100 may be in a dedicated enterprise environment—across a local area network or subnet—or any other suitable environment without departing from the scope of this disclosure. Indeed, while generally described or referenced in terms of an enterprise, the components and techniques may be implemented in any suitable environment, organization, entity, and such. Turning to the illustrated embodiment, environment 100 includes or is communicably coupled with server 102, one or more learners 104 or other users on clients, and network 112. In this embodiment, environment 100 is also communicably coupled with external content provider 108.

Server 102 comprises an electronic computing device operable to receive, transmit, process and store data associated with environment 100. Generally, FIG. 1 provides merely one example of computers that may be used with the disclosure. Each computer is generally intended to encompass any suitable processing device. For example, although FIG. 1 illustrates one server 102 that may be used with the disclosure, environment 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server. Server 102 may also be communicably coupled with a remote repository over a portion of network 112. While not illustrated, the repository may be any intra-enterprise, inter-enterprise, regional, nationwide, or other electronic storage facility, data processing center, or archive that allows for one or a plurality of clients (as well as servers 102) to dynamically store data elements, which may include any business, enterprise, application or other transaction data. For example, the repository may be a central database communicably coupled with one or more servers 102 and clients via a virtual private network (VPN), SSH (Secure Shell) tunnel, or other secure network connection. This repository may be physically or logically located at any appropriate location including in one of the example enterprises or off-shore, so long as it remains operable to store information associated with environment 100 and communicate such data to at least a subset of plurality of the clients (perhaps via server 102). As a possible supplement to or as a portion of this repository, server 102 normally includes some form of local memory.

The memory may include any memory or database module and may take the form of volatile or non-volatile memory including, without limitation, magnetic media, optical media, random access memory (RAM), read-only memory (ROM), removable media, or any other suitable local or remote memory component. For example, the memory may include some or all of strategy templates 225 and learning content 230. In this example, the memory may store a local copy of such data, while the repository stores master copies. Generally, a learning unit 230 covers a certain topic in a comprehensive and self-contained way. Learning units 230 comprise knowledge items, which typically have an assigned knowledge type and possibly other metadata such as media type, and relations between the knowledge items. Learning strategies 225 serve for defining rules for sequencing the knowledge items within any learning unit 230 when the unit is presented to one or more learners 104. Finite automatons can be considered automatons that are used for acceptance or checking whether a given input sequence complies with a particular regular expression. For this regular expression, it is typically possible to construct a finite automaton that accepts those input sequences that are allowed under the regular expression. At a high level, the finite automaton normally includes states and state transitions. As used herein, states generally capture portions of the acceptance test and transitions may represent elements of the input sequence that are to be accepted. Having a conditional regular expression, there are transitions that are conditions and that evaluate to true or false during the acceptance. More specifically, some processes may use a particular finite automaton, termed herein a bipartite finite automaton, as a convenient technique for algorithms that compute knowledge item sequences complying with a defined learning unit and strategy template.

As shown in example FIG. 5, strategy templates 225 and learning units 230 can be specified in a graphical environment using graphical elements. These elements would then be mapped to formal, textual representations, which can be more easily used by algorithms or processes. For example, strategy templates 225 and learning units 230 can be textually represented as regular expressions. With regard to a strategy template 225, the finite set of symbols S consists of a set of abstract knowledge items (or strategy items) that are of interest for the particular strategy. Each abstract knowledge item has some properties (such as a knowledge type) that help distinguish it from other abstract knowledge items within S. Relations among two or more abstract knowledge items are expressed by the structure of the regular expression. With regard to learning unit 230, the finite set of symbols S is simply the set of knowledge items (or learning items) used within the learning unit. Relations among two or more knowledge items are generally expressed by the structure of the regular expression. In this example, a generic strategy assessment algorithm assesses navigation options within a learning unit 230 according to a given strategy 225 based on these formal representations. These assessments are then used for providing overall navigation support to the learner 104. In certain cases, strategy templates 225 and learning units 230 may be represented or processed as bipartite, deterministic finite automatons. Such a representation is often useful for algorithms that compute possible sequences.

More specifically, strategy template 225 may be an automaton described by a set of abstract knowledge items associated with a particular knowledge type and possibly other metadata. These abstract knowledge items can be related to each other using relation types such as “didactically before” and “associated with.”In this example, “didactically before” gives a recommendation on the order of knowledge items how they should be sequenced for the learner and “associated with” identifies the relationship of several knowledge items that are closely related and should be presented as a dedicated sub-part of the sequencing process (but does not specify any policy on the order among the associated items). The strategy templates may make use of conditional expressions. The evaluation of such conditions may be indicated by the function eval: C→Boolean, where eval(c) evaluates to true whenever c evaluates to true. For purposes of this disclosure and the example descriptions therein, let S be a finite set of symbols S={s₁,s₂, . . . ,sₙ}, sεS be an element of S and r, r₁, r₂ be conditional regular expressions and cεS a Boolean expression. According to this definition, the disclosure may utilize the following conditional regular expressions:
1. the empty expression: ε
2. a single symbol s
3. a sequence of two conditional regular expressions r₁r₂
4. an alternative of two conditional regular expressions r₁|r₂
5. a arbitrary repetition of a conditional regular expression r*
6. a conditional occurrence of a conditional regular expression: c:r
   In order to simplify the notation of strategy template attributes, the disclosure may also make use of the following expressions:
7. [r] [symbol] r|ε
8. r⁺ [symbol] rr*
   The strategy unit item may also be associated with a “visited” attribute (“v”) that is evaluated while accepting a word that is specified by a regular expression. Generally, “v” is initialized as “false,” but becomes “true” for a part of a regular expression as soon as the part of the regular expression has been accepted by the corresponding automaton. With this visited attribute, the disclosure defines the following two abbreviations for regular expressions: i) let r₁, . . . , rₙ be regular expressions that are made up of mutually different symbol sets s_{1,1}, . . . s_{1,m}_{₁}, . . . , s_{n,1}, s_{n,m}_{ₙ} i.e. The mutual intersections of two of the symbol sets are empty; and ii) let v₁, . . . ,vₙ be the visited attributes for r₁, . . . ,rₙ. More specifically, the disclosure defines the following abbreviations:
9. <r₁, . . . ,rₙ> [symbol] ( [symbol] v₁:r₁, [symbol] v₂:r₂, . . . , [symbol] vₙ:rₙ)ⁿ, resulting in a permutation of regular expressions r₁, . . . ,rₙ
10. {r₁, . . . ,rₙ}* [symbol] ( [symbol] v₁:r₁, [symbol] v₂:r₂, . . . , [symbol] vₙ:rₙ)*, resulting in a subset of the regular expressions r₁, . . . , rₙ
11. {r₁, . . . ,rₙ}⁺ [symbol] ( [symbol] v₁:r₁, [symbol] v₂:r₂, . . . , [symbol] vₙ:rₙ)⁺, resulting in a non-empty subset of the regular expressions r₁, . . . ,rₙ
   This special condition demanded on r₁, . . . ,rₙ may reduce ambiguities when a specific regular expression has been visited and is a restriction that is valid for the purpose of the regular expressions. Each transition in such an automaton represents a symbol of the regular expression which in turn represents a knowledge item within the strategy template 225 or learning unit 230 or a condition given by the structure of the regular expression. With the foregoing understandings, let A=(Q, S, P, i, F) be a deterministic bipartite finite automaton where Q={q₁, . . . ,qₙ) is the set of states of the automaton, S={s₁, . . . ,sₙ} is its alphabet, P is a set of transitions qs::=q′ with q, q′εQ, sεS; iεQ is the start state of the automaton, and F⊂Q a set of final states of the automaton. The characteristic of being bipartite normally results in the following characteristics of the automaton:
1. S can be partitioned into two disjoint sets C and E with C∪E=T, C∩E=Ø where by the construction of the automaton in our case C is a set of conditions and E is a set of knowledge items
2. Q can be partitioned into two disjoint sets Q^{C} and Q^{E} with Q^{C}∪Q^{E}=Q, Q^{C}∩Q^{E}=Ø where by the construction of the automaton the following holds: let q^{C}εQ^{C}, q^{E}εQ^{E}, cεC and eεE, then each transition of P has either the form q^{C}c::=q^{E} or q^{E}e::=q^{C}
3. The start state i is an element of Q^{C}, iεQ^{C}
4. Since the automaton is deterministic a tuple of (q, s) with qεQ, sεS uniquely defines a transition in P of the form qs::=q′ if such a production exists; q′ is considered the target of (q, s), q′=target(q, s)
   In this way, bipartite automatons often help to systematically handle conditions that are introduced in conditional path expressions. For readability, this disclosure may distinguish between the learning unit automaton, representing a learning unit 230, and the strategy automaton, representing a strategy template 230, by using the corresponding indices S and L respectively. For example, the disclosure may distinguish between the bipartite finite automatons A_{L}=(Q_{L}, S_{L}, P_{L}, i_{L}, F_{L}) representing a learning unit automaton 230 and A_{S}=(Q_{S}, S_{S}, P_{S}, i_{S}, F_{S}) representing a strategy automaton 225.

The visited attribute for knowledge items of either automaton (225, 230) may be denoted by the attribute visited: E→Boolean, where visited(e) is true when the e has been visited. In some cases, a symbol e may occur within various transitions. During the course of an acceptance, visited(e) is normally assigned “true” the first time a transition containing e is applied. When looking for the best sequence in the particular learning unit 230 according to the invoked strategy template 225, learning management system 140 generally associates the knowledge items of the learning unit 230 with the knowledge items in the strategy template 225. Put another way, a knowledge item of the learning unit 230 corresponds to a knowledge item in the strategy template 225. This correspondence may be denoted using a predicate.

The predicate S_{L}≈S_{S}→Boolean specified upon a knowledge item e_{L} of a learning unit and knowledge item eₛ of a strategy template returns true if and only if the e_{L} is considered as corresponding to eₛ. A typical concrete definition of the corresponding predicate might follow the definition of the knowledge type hierarchy. According to this hierarchy, a knowledge item e_{L} corresponds to a knowledge item e_{S} if the knowledge type of e_{L} is of the same type or subtype as the knowledge type of e_{S}. The predicate might also be defined more sophisticatedly considering other attributes of the knowledge item. Note that the predicate ≈ normally results to “false” if one of its arguments relates to a condition that is part of the automaton. Regardless, correspondence (as well as many of the other principles described herein) may be defined using any suitable definition or denotation.

In order to simplify the formal notations within the assessment, this disclosure may utilize two auxiliary definitions: the notion of a direct path from a state to a knowledge item and the distance between those two. In this case, let A=(Q, S, P, i, F) be a finite bipartite automaton and c₀, . . . ,cₘ,e₀, . . . ,eₘεS, q₀, . . . qₘ,qₘ₊₁,q′₀, . . . , q′ₘεQ. Then, the sequence (q₀c₀q′₀e₀ . . . qₘcₘq′ₘeₘ) may be called a direct path from q to e, if:

(1) q=q₀ ˆ e=eₘ ˆ

(2) ∀0≦i≦m: eval(cᵢ) ˆ qᵢcᵢ::=q′ᵢ, q′ᵢeᵢ::=qᵢ₊₁ ε P ˆ

(3) ∀≦0<i<j≦m: i≠0 ˆ j≠m→qᵢ≠qⱼ

Further, this disclosure may define “m” as the length of the direct path. The minimum length of a direct path from q to e may be termed distance between q and e: distance(q, e). Finally the disclosure may indicate that e is reachable from q if a direct path exists from q to e. This direct path as a predicate may be indicated by:
path(q₀c₀q′₀e₀ . . . qₘcₘq′ₘeₘ, q, e)
   where the predicate evaluates to true when the above definition is fulfilled.

It is possible that conditional finite automatons might contain deadlocks or inner states that have—at a certain point in time—no transition that can be followed as all the associated conditions evaluate to false. But learning management system 140 may assume that this will not happen for learning units 230 because of the construction process of their associated regular expressions. Moreover, when applying an abstract knowledge item sequence defined by a strategy template 225 to a concrete sequence of knowledge items given by a learning unit 230, contradictions may occur or arise regarding the sequence. In order to resolve these potential conflicts learning management system 140 may assess the quality of a sequence given by a learning unit 230 according to the one predefined by the strategy template 225. For example, one distance measure can be used to assess the quality of an actual learning unit sequence with respect to an abstract sequence provided by strategy 225. In this example, each sequence simply describes the order in which a set of knowledge items is to be processed. Particularly, let seqₛ be a sequence according to strategy template 225 and seq_{L} be a sequence of learning unit 230. Thus, the example distance between these sequences can be defined as:

Δ(seq_{S}, seq_{L}):=weighting(# missed strategy items,

# superfluous learning unit items,

deviation of learning unit item order)

where i) # missed strategy items:=seq_{S}−seq_{L}, i.e. The items contained in seq_{S} but not in seq_{L}; ii) # superfluous learning unit items:=seq_{L}−seq_{S}, i.e. The items contained in seq_{L} but not in seq_{S}; and iii) deviation of learning unit item order:=minimum number of knowledge item exchange operations in seq_{S}∩seq_{L} to turn it compliant with the order in seq_{S}

Both learning unit 230 and learning strategy 225 may not specify a single sequence, but may instead specify a range of possible sequences. In this circumstance, learning management system 140 may identify an optimal learning unit sequence (with respect to the strategy) by computing the above introduced distance measure for any pair of possible sequences and selecting the one with the minimal distance. In some cases, the respective sequence sets may be infinite as learning units and strategies are represented as regular expressions. In these situations, learning management system 140 may implement a heuristic to limit the number of allowed repetitions (perhaps denoted by an “*” within the regular expressions) by the maximum number of knowledge items occurring either in learning unit 230 or the strategy expression 225.

In some embodiments, the memory (or the repository) may store these templates and learning content as one or more tables in a relational database described in terms of SQL statements or scripts. In another embodiment, the memory may store such information as various data structures in text files, eXtensible Markup Language (XML) documents, Virtual Storage Access Method (VSAM) files, flat files, Btrieve files, comma-separated-value (CSV) files, internal variables, or one or more libraries. Simply, this stored information may comprise one table or file or a plurality of tables or files stored on one computer or across a plurality of computers in any appropriate format. Indeed, some or all of the strategy or content data may be local or remote without departing from the scope of this disclosure. Further, the memory may store any other suitable data as appropriate.

For example, the memory may store or reference a large volume of information relevant to the planning, management, and follow-up of courses or other content. This example data includes information on i) course details, such as catalog information, dates, prices, capacity, time schedules, assignment of course content, and completion times; ii) personnel resources, such as trainers who are qualified to hold courses; iii) room details, such as addresses, capacity, and equipment; and iv) participant data for internal and external participants. The memory may also include any other appropriate data such as VPN applications or services, firewall policies, a security or access log, print or other reporting files, HTML files or templates, data classes or object interfaces, child software applications or sub-systems, and others.

Server 102 also includes one or more processors. Each processor executes instructions and manipulates data to perform the operations of server 102 such as, for example, a central processing unit (CPU), a blade, an application specific integrated circuit (ASIC), or a field-programmable gate array (FPGA). Although this disclosure typically discusses computers in terms of a single processor, multiple processors may be used according to particular needs and reference to one processor is meant to include multiple processors where applicable. In the illustrated embodiment, the processor executes enterprise resource planning (ERP) solution 135, thereby providing organizations with the strategic insight, ability to differentiate, increased productivity, and flexibility they need to succeed. With software such as ERP solution 135, the implementing entity may automate end-to-end processes and extend those processes beyond the particular organization to the entire system by incorporating customers, partners, suppliers, or other entities. For example, ERP solution 135 may include or implement easy-to-use self-services and role-based access to information and services for certain users, thereby possibly boosting productivity and efficiency. In another example, ERP solution 135 may include or implement analytics that enable the particular entity or user to evaluate performance and analyze operations, workforce, and financials on an entity and individual level for strategic and operational insight. ERP solution 135 may further include or implement i) financials to control corporate finance functions while providing support for compliance to rigorous regulatory mandates; ii) operations to support end-to-end logistics for complete business cycles and capabilities that improve product quality, costs, and time to market, and/or iii) corporate services to optimize both centralized and decentralized services for managing real estate, project portfolios, business travel, environment, health and safety, and quality. In the illustrated embodiment, ERP solution 135 also includes or implements some form of human capital management (in this case, learning) to maximize the profitability or other measurable potential of the users, with support for talent management, workforce deployment, and workforce process management. In certain cases, ERP solution 135 may be a composite application that includes, executes, or otherwise implements some or all of the foregoing aspects, which include learning management system 140 as illustrated.

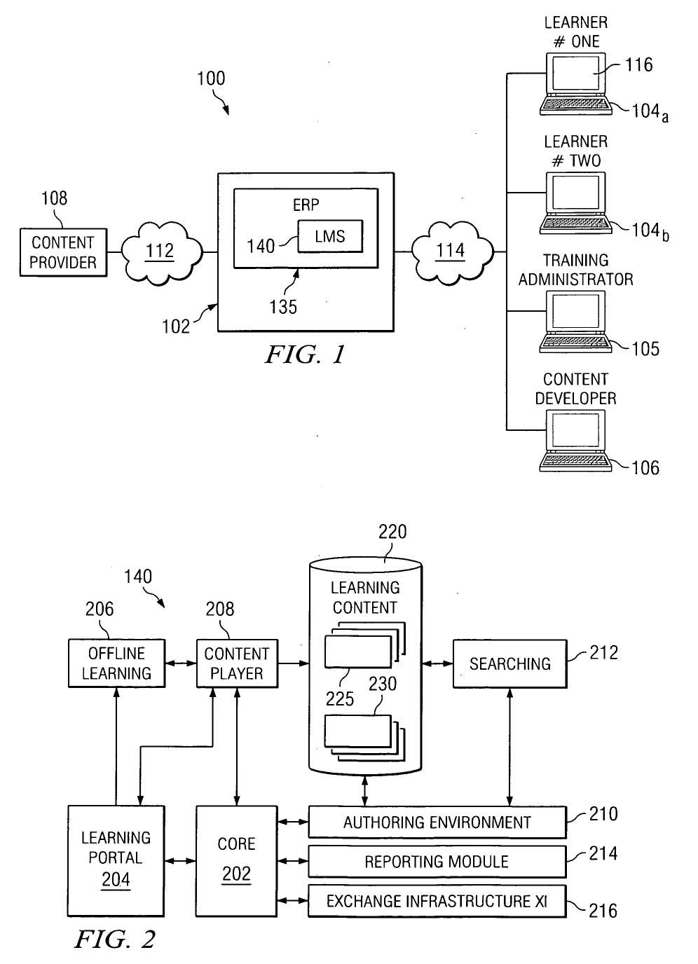

As briefly described above, learning management system 140 is any software operable to provide a comprehensive enterprise learning platform capable of managing and integrating business and learning processes and supporting all methods of learning, not restricted to e-learning or classroom training. As described in more detail in FIG. 2, learning management system 140 is often fully integrated with ERP solution 135 and includes an intuitive learning portal and a powerful training and learning management system, as well as content authoring, structuring, and management capabilities. Learning management system 140 offers back-office functionality for competency management and comprehensive assessment for performance management, and offers strong analytical capabilities, including support for ad hoc reporting. The solution uses a comprehensive learning approach to deliver knowledge to all stakeholders, and tailors learning paths to an individual's educational needs and personal learning style. Interactive learning units can be created with a training simulation tool that is also available.

Regardless of the particular implementation, “software” may include software, firmware, wired or programmed hardware, or any combination thereof as appropriate. Indeed, ERP solution 135 may be written or described in any appropriate computer language including C, C++, Java, J#, Visual Basic, assembler, Perl, any suitable version of 4GL, as well as others. For example, returning to the above described composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while ERP solution 135 is illustrated in FIG. 1 as including one sub-module learning management system 140, ERP solution 135 may include numerous other sub-modules or may instead be a single multi-tasked module that implements the various features and functionality through various objects, methods, or other processes. Further, while illustrated as internal to server 102, one or more processes associated with ERP solution 135 may be stored, referenced, or executed remotely. For example, a portion of ERP solution 135 may be a web service that is remotely called, while another portion of ERP solution 135 may be an interface object bundled for processing at the remote client. Moreover, ERP solution 135 and/or learning management system 140 may be a child or sub-module of another software module or enterprise application (not illustrated) without departing from the scope of this disclosure.

Server 102 may also include an interface for communicating with other computer systems, such as the clients, over networks, such as 112 or 114, in a client-server or other distributed environment. In certain embodiments, server 102 receives data from internal or external senders through the interface for storage in the memory and/or processing by the processor. Generally, the interface comprises logic encoded in software and/or hardware in a suitable combination and operable to communicate with networks 112 or 114. More specifically, the interface may comprise software supporting one or more communications protocols associated with communications network 112 or hardware operable to communicate physical signals.

Network 112 facilitates wireless or wireline communication between computer server 102 and any other local or remote computers, such as clients. Network 112, as well as network 114, facilitates wireless or wireline communication between computer server 102 and any other local or remote computer, such as local or remote clients or a remote content provider 108. While the following is a description of network 112, the description may also apply to network 114, where appropriate. For example, while illustrated as separate networks, network 112 and network 114 may be a continuous network logically divided into various sub-nets or virtual networks without departing from the scope of this disclosure. In some embodiments, network 112 includes access points that are responsible for brokering exchange of information between the clients. As discussed above, access points may comprise conventional access points, wireless security gateways, bridges, wireless switches, sensors, or any other suitable device operable to receive and/or transmit wireless signals. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Turning to network 114, as illustrated, it may be all or a portion of an enterprise or secured network. In another example, network 114 may be a VPN between server 102 and a particular client across wireline or wireless links. In certain embodiments, network 114 may be a secure network associated with the enterprise and certain local or remote clients.

Each client is any computing device operable to connect or communicate with server 102 or other portions of the network using any communication link. At a high level, each client includes or executes at least GUI 116 and comprises an electronic computing device operable to receive, transmit, process and store any appropriate data associated with environment 100. It will be understood that there may be any number of clients communicably coupled to server 102. Further, “client” and “learner,” “administrator,” “developer” and “user” may be used interchangeably as appropriate without departing from the scope of this disclosure. Moreover, for ease of illustration, each client is described in terms of being used by one user. But this disclosure contemplates that many users may use one computer or that one user may use multiple computers. As used in this disclosure, the client is intended to encompass a personal computer, touch screen terminal, workstation; network computer, kiosk, wireless data port, smart phone, personal data assistant (PDA), one or more processors within these or other devices, or any other suitable processing device or computer. For example, the client may be a PDA operable to wirelessly connect with external or unsecured network. In another example, the client may comprise a laptop that includes an input device, such as a keypad, touch screen, mouse, or other device that can accept information, and an output device that conveys information associated with the operation of server 102 or other clients, including digital data, visual information, or GUI 116. Both the input device and output device may include fixed or removable storage media such as a magnetic computer disk, CD-ROM, or other suitable media to both receive input from and provide output to users of the clients through the display, namely the client portion of GUI or application interface 116.

GUI 116 comprises a graphical user interface operable to allow the user of the client to interface with at least a portion of environment 100 for any suitable purpose, such as viewing application or other transaction data. Generally, GUI 116 provides the particular user with an efficient and user-friendly presentation of data provided by or communicated within environment 100. As shown in later FIGs, GUI 116 may comprise a plurality of customizable frames or views having interactive fields, pull-down lists, and buttons operated by the user. GUI 116 may be a learning interface allowing the user or learner 104 to search a course catalog, book and cancel course participation, and support individual course planning (e.g., by determining qualification deficits and displaying a learner's completed, started, and planned training activities). Learner 104 also may access and work through web based courses using the learning interface. The learning interface may be used to start a course, reenter a course, exit a course, and take tests. The learning interface also provides messages, notes, and special course offerings to the learner 104. GUI 116 may also be a course editor allowing the content developer to create the structure for the course content, which may be associated with certain metadata. The metadata may be interpreted by a content player of learning management system 140 (described below) to present a course to learner 104 according to a learning strategy selected at run time. In particular, the course editor may enable the author or content developer 106 to classify and describe structural elements, assign attributes to structural elements, assign relations between structural elements, and build a subject-taxonomic course structure. The course editor generates the structure of the course and may include a menu bar, a button bar, a course overview, a dialog box, and work space. The menu bar may include various drop-down menus, such as, for example, file, edit, tools, options, and help. The drop-down menus may include functions, such as create a new course, open an existing course, edit a course, or save a course. The button bar may include a number of buttons. The buttons may be shortcuts to functions in the drop down menus that are used frequently and that activate tools and functions for use with the course editor. The remaining portions of the example course editor interface may be divided in to three primary sections or windows: a course overview, a dialog box, and a workspace. Each of the sections may be provided with horizontal or vertical scroll bars or other means allowing the windows to be sized to fit on different displays while providing access to elements that may not appear in the window.

GUI 116 may also present a plurality of portals or dashboards. For example, GUI 116 may display a portal that allows users to view, create, and manage historical and real-time reports including role-based reporting and such. Generally, historical reports provide critical information on what has happened including static or canned reports that require no input from the user and dynamic reports that quickly gather run-time information to generate the report. Of course, reports may be in any appropriate output format including PDF, HTML, and printable text. Real-time dashboards often provide table and graph information on the current state of the data, which may be supplemented by presentation elements 140. GUI 116 is often configurable, supporting a combination of tables and graphs (bar, line, pie, status dials, etc.), and is able to build real-time dashboards, where presentation elements 140 (as well the displayed application or transaction data) may be relocated, resized, and such. It should be understood that the term graphical user interface may be used in the singular or in the plural to describe one or more graphical user interfaces and each of the displays of a particular graphical user interface. Indeed, reference to GUI 116 may indicate a reference to the front-end or other component of learning management system 140, as well as the particular interface or learning portal accessible via the client, as appropriate, without departing from the scope of this disclosure. In short, GUI 116 contemplates any graphical user interface, such as a generic web browser or touch screen, that processes information in environment 100 and efficiently presents the results to the user. Server 102 can accept data from the client via the web browser (e.g., Microsoft Internet Explorer or Netscape Navigator) and return the appropriate HTML or XML responses to the browser using network 112 or 114.

As mentioned above, learning units 230 and strategy templates 225 may be visually represented using graphical elements via GUI 116. For example, particular elements (such as nodes) can visually correspond with knowledge items (whether abstract or relatively concrete) and some other graphical elements (such as edges) can visually correspond with relations. Based on any suitable processing or using any appropriate characteristics, the correspondence between the graphical element and the formal representation may be mapped. In certain cases, other graphical notations might be introduced to achieve even more expressiveness. To achieve this, some or all of the following assumptions may be followed:
1) Within learning units 230, there may be two types of relations, “before” and “belongs to” the first of which is a directed one, the second an undirected one. Consequently, these may be represented as directed/undirected edges within the graph.
2) Similarly within strategy templates 225, there may be two types of relations, “didactically before” and “associated with” the first of which is a directed one, the second an undirected one. Consequently, these may be represented as directed/undirected edges within the graph.
3) Undirected relations/edges may have a transitive semantics, i.e. when two nodes A and B are related and B is also related with C, then A and C are also related.
4) Pairs of nodes directly or indirectly related by an undirected edge may not be related by a directed edge.
   These assumptions may be similarly extended for strategy templates 225, where the navigation support utilizes relations specified in learning unit 230 that take precedence over the relations defined in strategy template 225.

Learning management system 140 may derive a conditional regular expression from the graphical notation (or more precisely from its associated graph structure) similarly for both learning units 230 and strategy templates 225. For example, learning management system 140 may identify a graph G=(N, E) describing a strategy templates, where N represents the nodes and E the edges within that graph. The directed edges from E are denoted as E^{D}, the undirected edges as E_{U}. As first step, learning management system 140 may construct a condensed node set N*, in which nodes directly or indirectly connected via an undirected edge are melted together such as:
N*:={[n]|nεN ˆ [n]:={mεN: ∃k≧0 ∃n₀, . . . ,nₖεN ∀ 0≦i≦k: (nᵢ, nᵢ₊₁) ε E_{U} ˆ n=n₀ ˆ m=nₖ}}
Next, learning management system 140 may construct regular expressions for each condensed node within N*. For each node [n]εN*, learning management system 140 may assume [n]={n₀, . . . ,nₖ}. Learning management system 140 may then build regexp([n]):=<n₀, . . . ,nₖ>. In some cases, an additional condition is built upon directed edges from G reaching into a node contained in [n]. In these cases, learning management system 140 may combine the visited attributes of the source nodes of the respective edges:

$$cond ( [ n ] ) := {⩓}_{∀ ( m , p ) ∈ {E}^{D} \text{:} p ∈ [ n ]} v ( m )$$

Finally, the overall regular expression for G* with nodes [n₀], . . . ,[nₖ] may be defined as
<cond([n₀]): regexp([n₀]), . . . , cond([nₖ]): regexp([nₖ])>
In certain embodiments, learning management system 140 may implement similar techniques in order to transform learning units 230. Occasionally, there may be an exception that the conditional expression for condensed nodes (as well as the overall expression) is not built upon the permutation (< . . . >), but on the combination ({ . . . }*) of its elements.

FIG. 2 illustrates one example implementation of learning management system (LMS) 140. In the illustrated embodiment, LMS 140 comprises four example components, namely i) a management system core 202, which controls learning processes and manages and handles the administrative side of training; ii) a learning portal 204, which is the learner's springboard into the learning environment, which allows him to access the course offering and information on personal learning data and learning activities; iii) an authoring environment 210, where learning content and tests are designed and structured; and iv) a content management system 220, where learning content is stored and managed. Generally, LMS 140 is aimed at learners 104, trainers 105, course authors 106 and instructional designers, administrators, and managers.

Learners 104 log on to their personalized learning portal 204 from any suitable client via GUI 116. The learning portal 204 is the user's personalized point of access to the learning-related functions. Generally, learning portal 204 presents details of the complete education and training offering, such as traditional classroom training, e-learning courses (such as virtual classroom sessions or web-based training), or extensive curricula. Self-service applications enable learners 104 to enroll themselves for courses, prebook for classroom courses, and cancel bookings for delivery methods, as well as start self-paced learning units directly. If learner 104 wants to continue learning offline, he can often download the courses onto the client and synchronize the learning progress later. The learning portal 204 may be seamlessly integrated in an enterprise portal, where learner 104 is provided with access to a wide range of functions via one system. Such an enterprise portal may be the learner's single point of entry and may integrate a large number of role-based functions, which are presented to the user in a clear, intuitive structure. The learning portal 204 often gives learner 104 access to functions such as, for example, search for courses using i) find functions: finding courses in the course catalog that have keywords in the course title or description; and ii) extended search functions: using the attributes appended to courses, such as target group, prerequisites, qualifications imparted, or delivery method. Additional functions may include self-service applications for booking courses and canceling bookings, messages and notes, course appraisals, and special (or personalized) course offering including courses prescribed for the learner 104 on the basis of his or her role in the enterprise or the wishes of the respective supervisor or trainer and qualification deficits of learner 104 that can be reduced or eliminated by participating in the relevant courses. The learning portal 204 may also provide a view of current and planned training activities, as well as access to courses booked, including: i) starting a course; ii) reentering an interrupted course; iii) downloading a course and continuing learning offline; iv) going online again with a downloaded course and synchronizing the learning progress; v) exiting a course; and vi) taking a test.

On the basis of the information the learning management system 140 has about learner 104, the learning management system core 202 proposes learning units for the learner 104, monitors the learner's progress, and coordinates the learner's personal learning process. In addition, the learning management system core 202 is often responsible for managing and handling the administrative processes. Targeted knowledge transfer may use precise matching of the learning objectives and qualifications of a learning unit with the learner's level of knowledge. For example, at the start of a course, the management system core 202 may compare learning objectives already attained by the respective learner 104 with the learning objectives of the course. On the basis of this, core 202 determines the learner's current level and the required content and scope of the course. The resulting course is then presented to the learner 104 via a content player 208.

The content player 208 is a virtual teacher that tailors learning content to the needs of the individual learner 104 and helps him navigate through the course; content player 208 then presents the learning course to the learner 104. In certain embodiments, the content player 208 is a Java application that is deployed on a Java runtime environment, such as J2EE. In this case, it is linked with other systems such as a web application server and ERP solution 135 via the Java Connector. The individual course navigation may be set up at runtime on the basis of the learning strategy stored in the learner account. Using the didactical strategies, content player 208 helps ensure that the course is dynamically adapted to the individual learning situation and the preferences expressed by learner 104. At this point, the content player 208 then calculates dynamically adjusted learning paths and presents these to the learner 104—perhaps graphically—to facilitate orientation within a complex subject area. The learner 104 can resume working on an interrupted course at any time. At this point, the content player 208 guides the learner 104 to the spot at which training was interrupted.

Offline learning player 206 generally enables learners 104 to download network or other web-based courses from the learning portal 204 and play them locally. Locally stored courses are listed in the course list with an icon indicating the status of each course. The offline player 206 may guide the learner 104 through the course according to the preferred learning strategy. It may also dynamically adjust the number and sequence of learning objects to the learner's individual learning pattern. If the learner 104 interrupts a course, the offline player 206 reenters the course at the point of interruption the next time. The learner 104 can, at any point in time, resynchronize his offline learning progress with the learning portal 204 and either continue learning online or set the course to a completed status.

LMS core 202 may also include or invoke training management that would be an administrative side of LMS 140. This typically includes course planning and execution, booking and cancellation of course participation, and follow-up processing, including cost settlement. In training management, the training administrator 105 creates the course offering and can, for example, define training measures for individual learners 104 and groups of learners 104. The training administrator 105 creates the course catalog in training management and makes it available (partially or completely) to learners 104 in the learning portal 204 for reference and enrollment purposes. The training administrator 105 can typically administer internal and external participants and enroll them for courses to be delivered using various technologies and techniques. Training management supports numerous business processes involved in the organization, management, and handling of training. Training management can be configured to meet the requirements, work processes, and delivery methods common in the enterprise. Training measures are usually flexibly structured and may include briefings, seminars, workshops, virtual classroom sessions, web-based trainings, external web-based trainings, static web courses, or curricula. Training management includes functions to efficiently create the course offerings. Using course groups to categorize topics by subject area enables flexible structuring of the course catalog. For example, when training administrator 105 creates a new subject area represented by a course group, he can decide whether it should be accessible to learners 104 in the learning portal 202.

Reporting functions 214 in training management enable managers to keep track of learners'learning activities and the associated costs at times. Supervisors or managers can monitor and steer the learning processes of their employees. They can be notified when their employees request participation or cancellation in courses and can approve or reject these requests. LMS 140 may provide the training manager with extensive support for the planning, organization, and controlling of corporate education and training. Trainers need to have up-to-the-minute, reliable information about their course schedules. There is a wide range of reporting options available in training management to enable the trainer to keep track of participants, rooms, course locations, and so on.

Authoring environment 210 contains tools and wizards that content developers 106 and instructional designers can use to create or import external course content. External authoring tools can be launched directly via authoring environment 210 to create learning content that can be integrated into learning objects and combined to create complete courses (learning nets). Attributes may be appended to content, thereby allowing learners 104 to structure learning content more flexibly depending on the learning strategy they prefer. Customizable and flexible views allow subject matter experts and instructional designers to configure and personalize the authoring environment 210. To create the HTML pages for the content, the user can easily and seamlessly integrate editors from external providers or other content providers 108 into LMS 140 and launch the editors directly from authoring environment 210. Authoring environment 210 often includes a number of tools for creating, structuring, and publishing course content and tests to facilitate and optimize the work of instructional designers, subject matter experts, and training administrators 105. Authoring environment 210 may contain any number of components or sub-modules such as an instructional design editor is used by instructional designers and subject matter experts to create and structure learning content (learning nets and learning objects), a test author is used by instructional designers and subject matter experts to create web-based tests, and a repository explorer is for training administrators and instructional designers to manage content. Authoring environment 210 may also be used to define strategy templates 220.

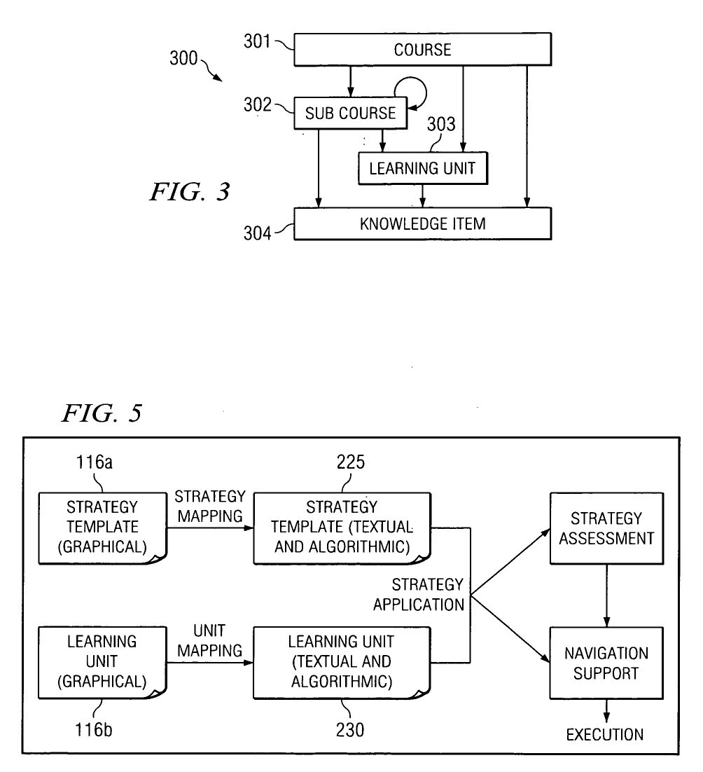

In the illustrated embodiment, course content is stored and managed in content management system 220. Put another way, LMS 140 typically uses the content management system 220 as its content storage location. But a WebDAV (Web-based Distributed Authoring and Versioning) interface (or other HTTP extension) allows integration of other WebDAV-enabled storage facilities as well without departing from the scope of this disclosure. Content authors or developers 106 publish content in the back-end training management system. Links to this content assist the training administrator 105 in retrieving suitable course content when planning web-based courses. A training management component of LMS 140 may help the training administrator 105 plan and create the course offering; manage participation, resources, and courses; and perform reporting. When planning e-learning courses, the training administrator 105 uses references inserted in published courses to retrieve the appropriate content in the content management system for the courses being planned. Content management system 220 may also include or implement content conversion, import, and export functions, allowing easy integration of Sharable Content Object Reference Model (SCORM)-compliant courses from external providers or other content providers 108. Customers can create and save their own templates for the various learning elements (learning objects, tests, and so on) that define structural and content-related specifications. These provide authors with valuable methodological and didactical support. LMS 140 and its implemented methodology typically structure content so that the content is reusable and flexible. For example, the content structure allows the creator of a course to reuse existing content to create new or additional courses. In addition, the content structure provides flexible content delivery that may be adapted to the learning styles of different learners. E-learning content may be aggregated using a number of structural elements arranged at different aggregation levels. Each higher level structural element may refer to any instances of structural elements of a lower level. At its lowest level, a structural element refers to content and may not be further divided. According to one implementation shown in FIG. 3, course material 300 may be divided into four structural elements: a course 301, a sub-course 302, a learning unit 303, and a knowledge item 304.

Starting from the lowest level, knowledge items 304 are the basis for the other structural elements and are the building blocks of the course content structure. Each knowledge item 304 may include content that illustrates, explains, practices, or tests an aspect of a thematic area or topic. Knowledge items 304 typically are small in size (i.e., of short duration, e.g., approximately five minutes or less). Any number of attributes may be used to describe a particular knowledge item 304 such as, for example, a name, a type of media, and a type of knowledge. The name may be used by a learning system to identify and locate the content associated with a knowledge item 304. The type of media describes the form of the content that is associated with the knowledge item 304. For example, media types include a presentation type, a communication type, and an interactive type. A presentation media type may include a text, a table, an illustration, a graphic, an image, an animation, an audio clip, and a video clip. A communication media type may include a chat session, a group (e.g., a newsgroup, a team, a class, and a group of peers), an email, a short message service (SMS), and an instant message. An interactive media type may include a computer based training, a simulation, and a test.

Knowledge item 304 also may be described by the attribute of knowledge type. For example, knowledge types include knowledge of orientation, knowledge of action, knowledge of explanation, and knowledge of source/reference. Knowledge types may differ in learning goal and content. For example, knowledge of orientation offers a point of reference to the learner, and, therefore, provides general information for a better understanding of the structure of interrelated structural elements. Each of the knowledge types are described in further detail below.

Knowledge items 304 may be generated using a wide range of technologies, often allowing a browser (including plug-in applications) to be able to interpret and display the appropriate file formats associated with each knowledge item. For example, markup languages (such as HTML, a standard generalized markup language (SGML), a dynamic HTML (DHTML), or XML), JavaScript (a client-side scripting language), and/or Flash may be used to create knowledge items 304. HTML may be used to describe the logical elements and presentation of a document, such as, for example, text, headings, paragraphs, lists, tables, or image references. Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash allows a pixel-precise positioning of graphical elements to generate impressive and interactive applications for presentation of course material to a learner.

Learning units 303 may be assembled using one or more knowledge items 304 to represent, for example, a distinct, thematically-coherent unit. Consequently, learning units 303 may be considered containers for knowledge items 304 of the same topic or knowledge type and possibly other metadata such as media type. Learning units 303 also may be considered relatively small in size (i.e., duration) though larger than a knowledge item 304. In addition, there might be some relations between knowledge items 304 that explain the “matter-of-fact” relationship between these items. In certain cases, there are two types of these relationships (that are often similar to the relation types used within strategy descriptions): “before” and “belongs to.” Two concrete knowledge items 304 can be related by a “before” relationship in order to enforce a special order for the sequencing of the items within learning unit 303. For example, an author might use the “before” relation in order to relate two knowledge items 304 that carry explanation knowledge where the second item builds upon the first one. The “belongs to” relation describes that two or more knowledge items 304 belong to each other due to their particular nature. For example, an author designing a learning unit with two pairs of example and explanation items might use this relation in order to relate each example with its corresponding explanation.

Sub-courses 302 may be assembled using other sub-courses 302, learning units 303, and/or knowledge items 304. The sub-course 302 may be used to split up an extensive course into several smaller subordinate courses. Sub-courses 302 may be used to build an arbitrarily deep nested structure by referring to other sub-courses 302.

Courses may be assembled from the subordinate structural elements including sub-courses 302, learning units 303, and knowledge items 304. To foster maximum reuse, structural elements should be self-contained and context free. Structural elements also may be tagged with metadata that is used to support adaptive delivery, reusability, and search/retrieval of content associated with the structural elements. For example, learning object metadata (LOM), per maps typically defined by the IEEE “Learning Object Metadata Working Group,” may be attached to individual course structure elements. The metadata may be used to indicate learner competencies associated with the structural elements. Other metadata may include a number of knowledge types (e.g., orientation, action, explanation, and resources) that may be used to categorize structural elements.

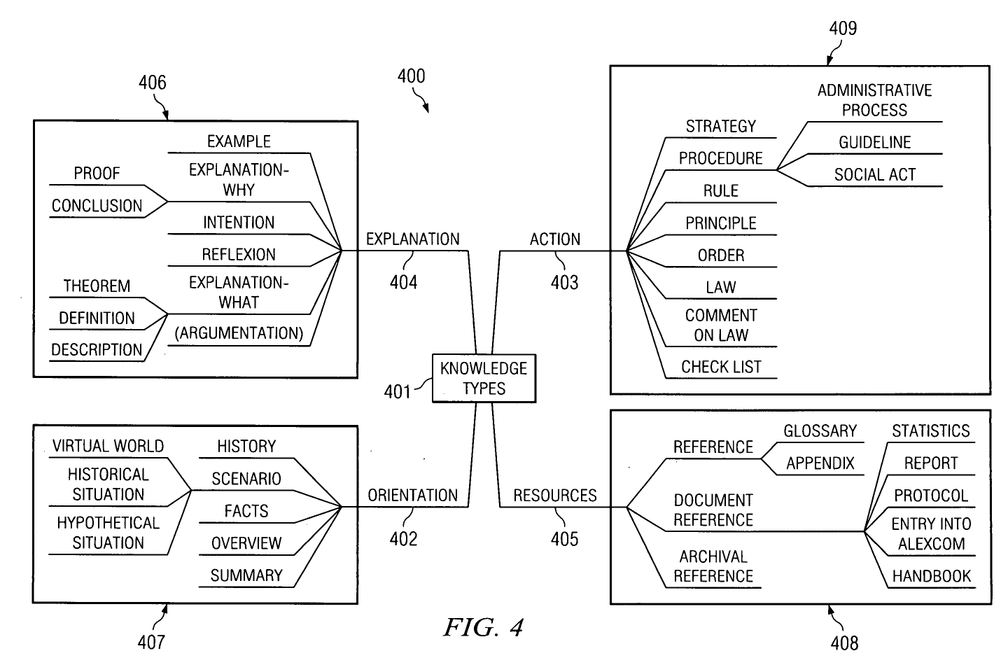

As shown in FIG. 4, structural elements may be categorized using a didactical ontology 400 of knowledge types 401 that includes orientation knowledge 402, action knowledge 403, explanation knowledge 404, and resource knowledge 405. Orientation knowledge 402 helps a learner 104 to find their way through a topic without being able to act in a topic-specific manner and may be referred to as “know what.” Action knowledge 403 helps a learner to acquire topic related skills and may be referred to as “know how.” Explanation knowledge 404 provides a learner with an explanation of why something is the way it is and may be referred to as “know why.” Resource knowledge 405 teaches a learner where to find additional information on a specific topic and may be referred to as “know where.”

The four knowledge types (orientation, action, explanation, and reference) may be further divided into a fine grained ontology. For example, orientation knowledge 402 may refer to sub-types 407 that include a history, a scenario, a fact, an overview, and a summary. Action knowledge 403 may refer to sub-types 409 that include a strategy, a procedure, a rule, a principle, an order, a law, a comment on law, and a checklist. Explanation knowledge 404 may refer to sub-types 406 that include an example, an intention, a reflection, an explanation of why or what, and an argumentation. Resource knowledge 405 may refer to sub-types 408 that include a reference, a document reference, and an archival reference.

Dependencies between structural elements may be described by relations when assembling the structural elements at one aggregation level. A relation may be used to describe the natural, subject-taxonomic relation between the structural elements. A relation may be directional or non-directional. A directional relation may be used to indicate that the relation between structural elements is true only in one direction. Directional relations should be followed. Relations may be divided into two categories: subject-taxonomic and non-subject taxonomic.

Subject-taxonomic relations may be further divided into hierarchical relations and associative relations. Hierarchical relations may be used to express a relation between structural elements that have a relation of subordination or superordination. For example, a hierarchical relation between the knowledge items A and B exists if B is part of A. Hierarchical relations may be divided into two categories: the part/whole relation (i.e., “has part”) and the abstraction relation (i.e., “generalizes”). For example, the part/whole relation “A has part B” describes that B is part of A. The abstraction relation “A generalizes B” implies that B is a specific type of A (e.g., an aircraft generalizes a jet or a jet is a specific type of aircraft).

Associative relations may be used refer to a kind of relation of relevancy between two structural elements. Associative relations may help a learner obtain a better understanding of facts associated with the structural elements. Associative relations describe a manifold relation between two structural elements and are mainly directional (i.e., the relation between structural elements is true only in one direction). Examples of associative relations include “determines,” “side-by-side,” “alternative to,” “opposite to,” “precedes,” “context of,” “process of,” “values,” “means of,” and “affinity.”

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to,” “alternative to,” and “analogous to.” The “opposite to” relation implies that two structural elements are opposite in reference to at least one quality. The “precedes” relation describes a temporal relationship of succession (e.g., A occurs in time before B (and not that A is a prerequisite of B). The “context of” relation describes the factual and situational relationship on a basis of which one of the related structural elements may be derived. An “affinity” between structural elements suggests that there is a close functional correlation between the structural elements (e.g., there is an affinity between books and the act of reading because reading is the main function of books).

Non Subject-Taxonomic relations may include the relations “prerequisite of” and “belongs to” The “prerequisite of” and the “belongs to” relations do not refer to the subject-taxonomic interrelations of the knowledge to be imparted. Instead, these relations refer to the progression of the course in the learning environment (e.g., as the learner traverses the course). The “prerequisite of” relation is directional whereas the “belongs to” relation is non-directional. Both relations may be used for knowledge items 304 that cannot be further subdivided. For example, if the size of the screen is too small to display the entire content on one page, the page displaying the content may be split into two pages that are connected by the relation “prerequisite of.”

Another type of metadata is competencies. Competencies may be assigned to structural elements, such as, for example, a sub-course 302 or a learning unit 303. The competencies may be used to indicate and evaluate the performance of a learner as learner 104 traverses the course material. A competency may be classified as a cognitive skill, an emotional skill, a senso-motorical skill, or a social skill.

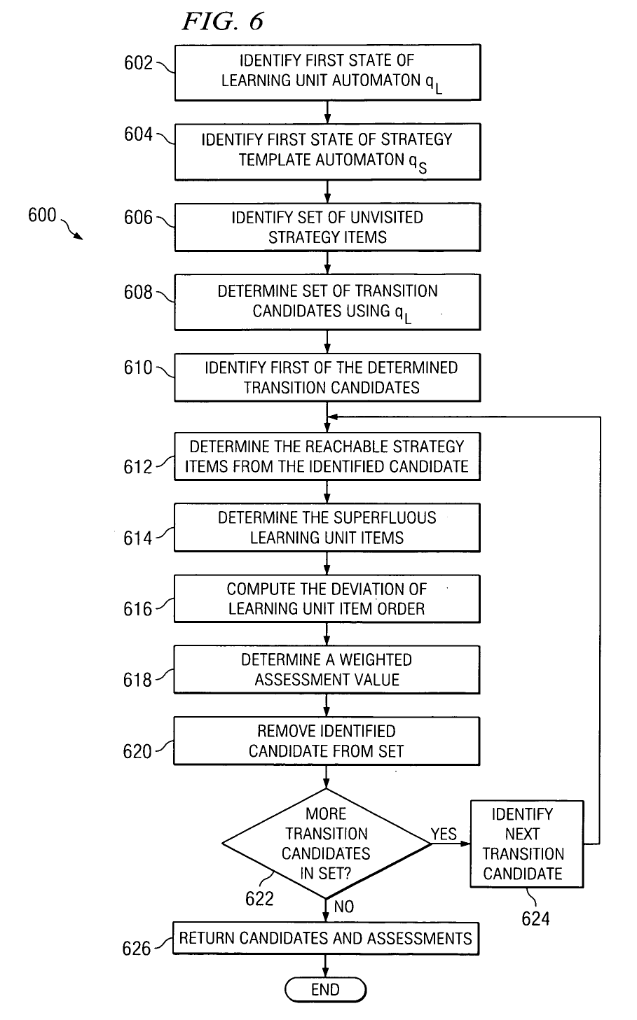

FIGS. 6-11 are flowcharts illustrating example methods, 600 through 1100 respectively, for creating, managing, or utilizing learning strategies in accordance with certain embodiments of the present disclosure. Generally, the example methods 600, 700, 800, 900, and 1000 compute data that may be used in a modified way for any of the intermediate automatons resulting from the transformation steps given by example method 1100, as well as by directly using the graph representation of strategy templates and learning units or the conditional regular expressions derived therefrom. In fact, the transformations from learning units and strategy templates into conditional regular expressions as well as the transformations in 1100 are often done for the sake of simplicity and efficiency of the described methods. Generally, the following description focuses on the operation of the client within learning management system 140, perhaps using GUI 116 or content player 208, to perform these methods. Moreover, any reference to a particular implementation of the network-based application is meant to include the use of an API or other similar software or interface. For example, the server portion of learning management system 140 may assess the learning strategies, while the content player 208 presents navigation options or otherwise provides navigation support to the user. Simply, environment 100 contemplates using any appropriate combination and arrangement of logical elements implementing some or all of the described functionality. Indeed, any suitable environment, system, or component may implement the following or other similar techniques.

FIG. 6 is a flow chart illustrating an example method 600 for assessing candidates for a learning strategy according to one embodiment of the present disclosure. Generally, method 600 describes one technique for assessing different sequencing options within learning unit 230 according to a given strategy template 225. At a high level, method 600 performs a local assessment that can be applied at any stage of the navigation through learning unit 230. The local assessment is often more efficient than a global optimization. In some embodiments, the technique is based on a bipartite finite automaton for each of the strategy template 225 and the learning unit 230. More specifically, having identified (or received) a specific state in the learning unit automaton, method 600 evaluates a set of potential strategy items. For each item, an assessment is performed or executed according to the above introduced quality criteria. The selected item then drives the execution of both automatons.

Method 600 begins at step 602, where LMS 140 identifies a first state learning unit automaton 230 and, at step 604, identifies a first state strategy template automaton 225. Next, LMS identifies the set of unvisited strategy items at step 606. Based on the current state of learning unit automaton 230, LMS 140 then determines, computes, selects, requests, or otherwise identifies a set of reachable transitions in learning unit automaton that correspond with a strategy item at step 608. From this set of candidates, a first transition candidate is selected at step 610.

Once the first item has been identified, LMS 140 then assesses missed strategy items by first computing the not yet visited (but still reachable) strategy items in the learning unit automaton 230 at step 612. Next, at step 614, superfluous learning unit items are then assessed. At step 616, LMS 140 assesses deviation of the particular learning unit item order. Usually based on the number of missed items, the superfluous items, and the computed deviation, LMS 140 then computes a weighted assessment value at step 618. This weighting assessment may be configured in various ways. For example the assessment could concentrate on capturing as many knowledge items from the strategy template as possible. In this case, the weighting function would simply count the number of missed items. In another example, more emphasis may be placed on the order of the visited knowledge items specified by the strategy. To help ensure that the current candidate is not processed again, it may be removed from the set as indicated at step 620. If there are more unprocessed transitional candidates in the set at decisional step 622, then the next candidate is identified at step 624 and processing returns to step 612. Once identified transition candidates have been processed, then the particular assessment process returns candidates and assessments to any requesting process at step 626. For example, the assessment process may follow the logical of the pseudo code included below:
q_{L}:=current state of learning unit automaton
q_{S}:=current state of strategy template automaton

notVisitedStrategyItems:=set of strategy items that have not been visited yet assessment(q_{L}, q_{S}, notVisitedStrategyItems)

{

candidateTransitions := computeTransitionCandidates(q_{L});
for each (q*_{L},e*_{L}) ∈ candidateTransitions) {

reachableItems := computeReachableStrategyItems(q*_{L},e*_{L})
numberOfMissedItems := |notVisitedStrategyItems −
reachableItems|
numberOfSuperfluousItems := distance(q_{L},e*_{L})
(strategyCandidate[q*_{L},e*_{L}], deviation) :=
computeDeviationAndDevTarget(q_{S},e*_{L})
assessment[q*_{L},e*_{L}] :=
weightingFunction(numberOfMissedItems,

numberOfSuperfluousItems, deviation)

}
return (candidateTransitions, assessment[candidateTransitions],

strategyCandidate[candidateTransitions])

}

Of course, the foregoing pseudo code is for example purposes only and may not represent the programmatic, logic, or data flow implementing processes similar to that described in method 600. For example, the described assessment process may be included in an object that has the candidate transitions as a global parameter, thereby reducing or eliminating the step of returning the assessment results.

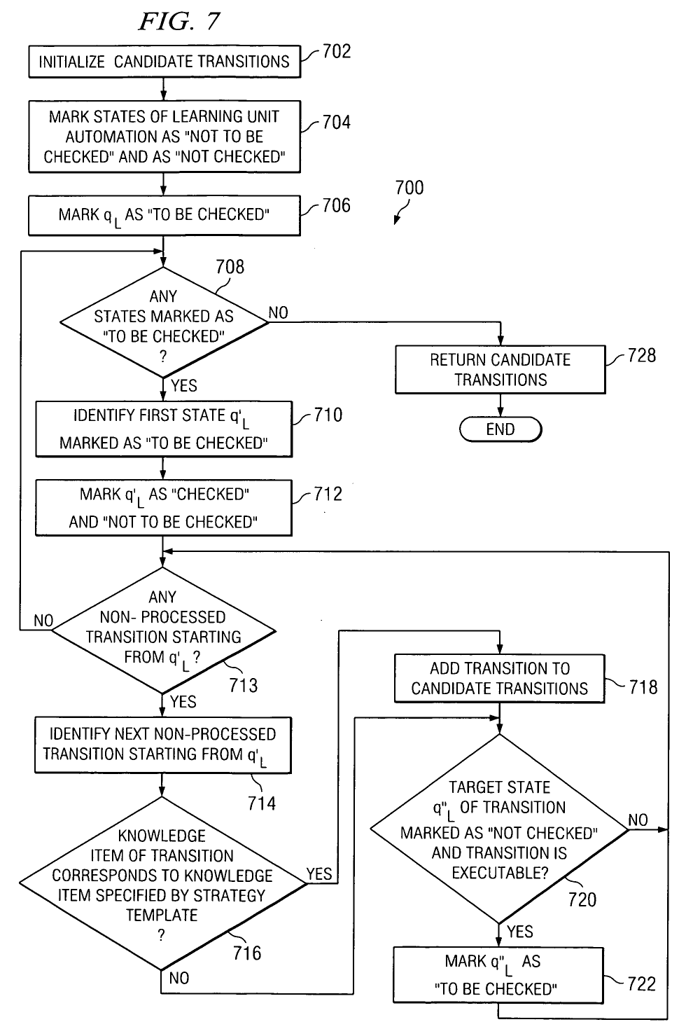

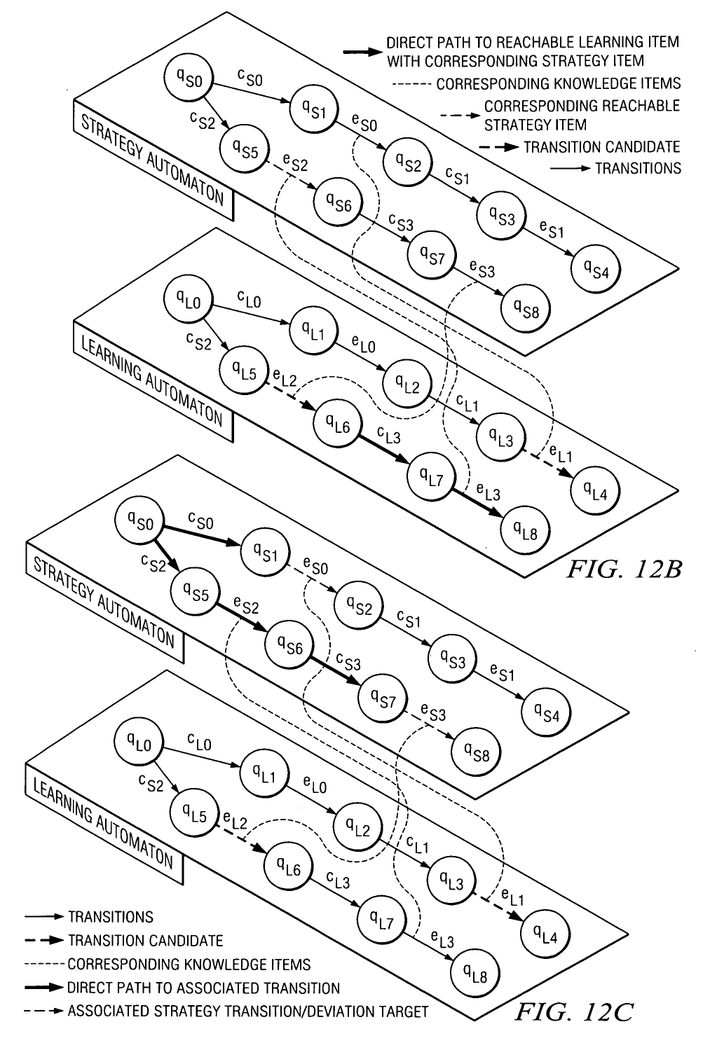

FIG. 7 is a flow chart illustrating an example method 700 for determining transition candidates according to one embodiment of FIG. 6 or other similar methods. For a given state q_{L} of the learning unit automaton 230, the transition candidates set includes the next reachable transitions in the learning unit automaton 230 (or the associated knowledge item) that correspond with a strategy item of the strategy automaton 225.
transitionCandidates: Q_{L}→ [symbol] (Q_{L}×S_{L})
transitionCandidates(q_{L}):={(q*_{L}, e*_{L})ε Q_{L}×S_{L}|∃c₀, . . . ,cₘ,e₀, . . . ,eₘεS_{L}, q₀, . . . qₘ,q′₀, . . . ,q′ₘεQ_{L}: path(q₀c₀q′₀e₀ . . . qₘcₘq′ₘeₘ, q_{L}, e*_{L}) ˆ q′ₘ=q*_{L} ˆ ∃e_{S}εS_{S}: e*_{L}≈e_{S} ˆ ∀0≦i<m ∀ e_{S}′εS_{S}: [symbol] eᵢ≈e_{S}′}
   In some cases, eₘ=e*_{L} may be guaranteed by the fact of the direct path from q_{L} to e*_{L}. For example, FIG. 12A shows as an example section of a learning automaton 230 and strategy automaton 225. The current state of the learning automaton 230 is q_{L0}. The thin dotted curved lines show corresponding knowledge items of the two automatons (e_{L2}≈e_{S3}, e_{L3}≈e_{S2}, e_{L1}≈e_{S0}). Further, this example illustration shows the two possible candidate transitions for q_{L0}, assuming that all conditions evaluate to true, which are (q_{L5}, e_{L2}) and (q_{L3}, e_{L1}) together with the direct paths to the candidate transitions. One further restriction on those transitions may be that they are the next reachable ones. In other words, for each transition, there may be no other transition between the state q_{L} and the transition in question that is a knowledge item that corresponds with a strategy item.

Generally, example method 700 describes computing possible transition candidates in the learning unit automaton 230 by first following the learning unit automaton 230 starting from q_{L}. This technique then computes those transitions in the learning unit automaton 230 that can be reached from that state and that corresponds with any knowledge item (or, more specifically, the knowledge item associated with each transition) specified by the learning strategy 225. Illustrated method 700 begins at step 702, where a candidateTransitions parameter or variable is initialized. Next, at step 704, at least a subset (and typically all) of the states for a particular learning unit automaton 230 are each marked as “not to be checked” and as “not checked.” As illustrated at step 706, LMS 140 marks a first learning state q_{L} “to be checked” as appropriate. Once the states have been marked, LMS 140 then begins selecting a first state that is marked “to be checked”. If there aren't any learning unit states to be checked at decisional step 708, then the candidate transitions are returned at step 728 or otherwise identified and subsequently processed. For example, at this early stage, if there are no learning unit states to be processed, then there are no candidate transitions. Otherwise, this first state to be checked is selected or otherwise identified at step 710.

This selected state is then marked “checked” at step 710 to help ensure that the state is not processed more than once. Then, for each transition starting from the selected state, LMS 140 determines if the transition corresponds to a particular strategy item. For example, LMS 140 determines at step 713 if there is a transition starting from the selected state at all and if there is one LMS 140 selects a first transition from the selected state at step 714. Next, using any suitable technique, it determines if the symbol of the transition corresponds to a particular strategy item from strategy template automaton 225 at decisional step 716. If it does, then LMS 140 adds the transition to the candidateTransitions variable at step 718. Next, if the target state of this transition is marked as “not checked” and the transition is executable (typically meaning that the transition either comprises a knowledge item or if it comprises a condition, then the condition evaluates to true) at decisional step 720, then the target state is marked as “to be checked” at step 722. This processing of transitions continues until all transitions starting from the selected state have been processed as shown at decisional step 713. Once the state has been processed, then processing returns to step 708 until there are no more states to be checked, at which point the candidateTransitions—if any—are returned at step 728.

For example, a process similar to that illustrated in FIG. 7 may be implemented by the following pseudo code, which computes the set starting from an arbitrary state q_{L}.

computeTransitionCandidates (q_{L}) {

candidateTransitions := { }
ToBeChecked := {q_{L}}
Checked := { }
while (ToBeChecked ≠ { }) {

q′_{L} := select element of ToBeChecked
ToBeChecked := ToBeChecked − {q′_{L}}
Checked := Checked + {q′_{L}}
for each (q′_{L},s_{L},q″_{L}) ∈ transitions(q′_{L})) {

if (∃ e_{S}∈S_{S}: e_{S}≈s_{L}) {

candidateTransitions := candidateTransitions +
{(q′_{L},s_{L})}

}
else if (q″_{L} ∉ Checked [symbol] (s_{L}∈C_{L} [symbol] eval(s_{L}))) {

ToBeChecked := ToBeChecked + {q″_{L}}

}

}

}
return candidateTransitions;

}

Of course, the foregoing pseudo code is for example purposes only and may not represent the programmatic, logic, or data flow implementing processes similar to that described in method 700 to determine the set of candidate transitions starting from an arbitrary state of the learning unit automaton.

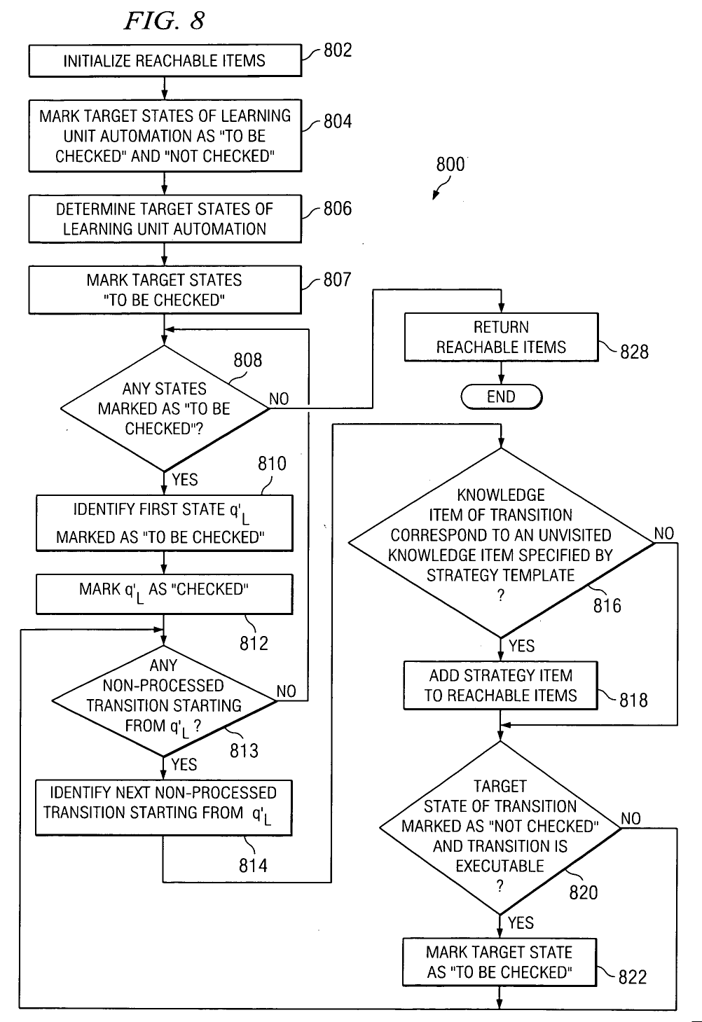

FIG. 8 is a flow chart illustrating an example method 800 for identifying reachable strategy items according to one embodiment of FIG. 6 or other similar methods. The next important part for our assessment is to compute the set of the still reachable, not yet visited strategy items for each of the transition candidates. For a specific candidate (q_{L}, e_{L}), this set is given as follows:
reachableStrategyItems: Q_{L}×S_{L}→ [symbol] (S_{S})
reachableStrategyItems(q_{L}, e_{L}):={e*_{S} εSₛ|∃c₀, . . . ,cₘ,e₀, . . . ,eₘεS_{L}, q₀, . . . qₘ,q′₀, . . . ,q′ₘεQ_{L}: path(q₀c₀q′₀e₀ . . . qₘcₘq′ₘeₘ, q₀, e*_{L}) ˆ q_{L}e_{L}::=q₀εP_{L} ˆ e*_{L}≈e*ₛ ˆ [symbol] visited(e*_{S})}
   For a given transition, this set includes still reachable (but not yet visited) strategy items, each of which normally has the following characteristic: starting from the target state of the given transition, a learning unit item is reachable that corresponds to a not yet visited strategy item. For example, FIG. 12B shows the reachable strategy items for our example automatons. Assuming that c_{L3} evaluates to true and none of the knowledge items has been visited so far, this is the set {e_{S2}} for the candidate transition (q_{L5}, e_{L2}) and it is the empty set for (q_{L3}, e_{L1}).

Generally, method 800 follows the learning unit automaton 230 starting from a given candidate transition. The example technique then computes the target states in the learning unit automaton 230 that can be reached from the start state of the candidate transition and that correspond with any not yet visited strategy item. This results in an estimate of the number of the finally missed strategy items (such as strategy items that cannot be reached the technique described above) for a particular transition candidate. For example, illustrated method 800 begins at step 802, where a reachableItems variable or parameter is initialized. States of the learning unit automaton are initially marked “not to be checked” and “not checked” at step 804. Using a given candidate transition, LMS 140 then identifies its target states in the particular learning unit automaton 230 to be processed at step 806. These target states—if any—are marked “to be checked” at step 807. Then, while there are states to be processed (as shown by decisional step 808), LMS 140 identifies a first state to be checked at step 810. As it is currently being processed, this identified state is then removed from the items to be processed (i.e., marked as “checked”) at step 812. Next, the transitions starting from the selected learning unit state are processed, if there are any, at decisional step 813.

The first of these transitions is selected at step 814. Then, at decisional step 816, LMS 140 determines if the symbol of the selected transition corresponds to a strategy item (typically if this strategy item has not yet been visited). If it does, then LMS 140 identifies it as one of the reachableItems at step 818. At decisional step 820, LMS 140 determines if the target state of the transition is marked as “not checked” and if the transition is executable. If it is, then the target state is marked as “to be checked” at step 822. This processing continues for other transitions both from the particular learning state (and its potential targets) as shown at decisional steps 813 and 814. Once there are no more transitions of this particular learning state, then processing returns to step 806, where it is determined if there are more states to process. Once all of the learning unit states have been processed, then the reachable items (if any) are returned at step 824.

For example, a process similar to that illustrated in FIG. 8 may be implemented by the following pseudo code, which computes the set of still reachable, but not yet visited strategy items:

computeReachableStrategyItems (q_{L},s_{L}) {

reachableItems := { };
ToBeChecked := {q′_{L} | q_{L}s_{L}::= q′_{L}∈P_{L}}
Checked := { }
while (ToBeChecked ≠ { }) {

q′_{L} := select element of ToBeChecked
ToBeChecked := ToBeChecked − {q′_{L}}
Checked := Checked + {q′_{L}}
for each (q′_{L},s_{L},q″_{L}) ∈ transitions(q′_{L})) {

if (s_{L}∈E_{L} [symbol] ∃ s_{S}∈S_{S}: e_{S}∈S_{S}: e_{S}≈s_{L} [symbol] [symbol] visited(s_{S}){

reachableItems := reachableItems + {s_{S}}

}
if (q″_{L} ∉ Checked [symbol] (s_{L}∈C_{L} [symbol] eval(s_{L}))) {

ToBeChecked := ToBeChecked + {q″_{L}}

}

}

}
return reachableItems;

}

Of course, the foregoing pseudo code is for example purposes only and may not represent the programmatic, logic, or data flow implementing processes similar to that described in method 800 to determine the set of reachable strategy items starting from a given transition of the learning unit automaton.

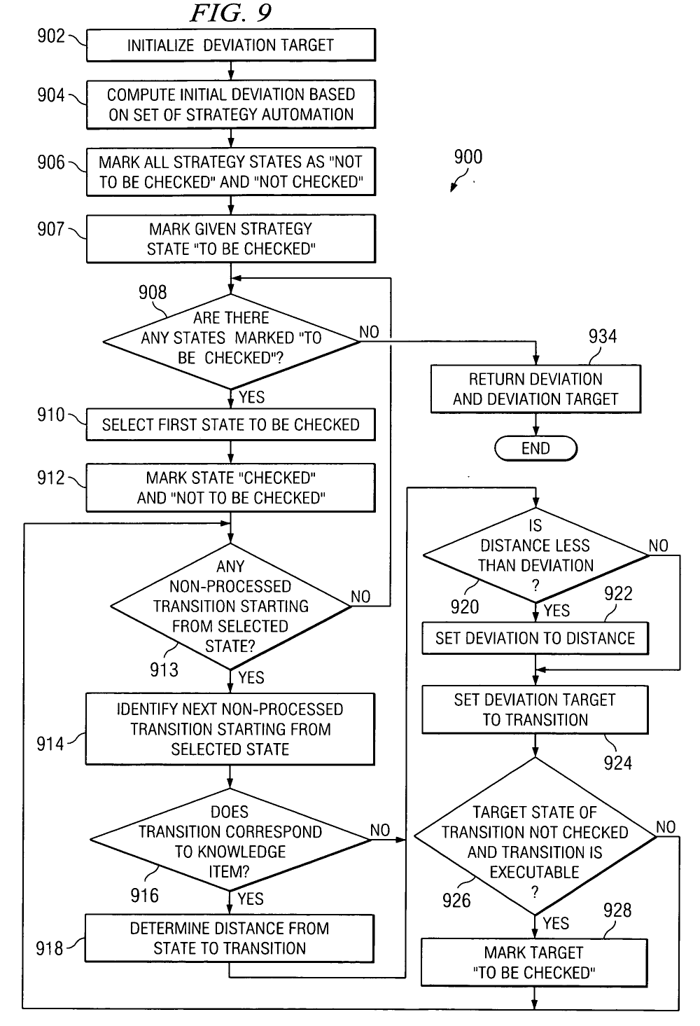

FIG. 9 is a flow chart illustrating an example method 900 for computing a deviation of a learning unit item order according to one embodiment of FIG. 6 or other similar methods. In order to compute the deviation for a specific candidate transition, similar processes may first compute the set of associated strategy items for that candidate. This set is usually given by the set of those transitions of the strategy automaton that can be reached from its current state that (more precisely: the associated knowledge item) corresponding to the knowledge item of the candidate transition of the learning automaton 230.
associatedStrategyTransitions: Q_{S}×S_{L}→ [symbol] (Q_{S}×S_{S})
associatedStrategyTransitions(q_{S}, e_{L}):={(q*_{S}, e*_{S}) εQ_{S}×S_{S}|∃c₀, . . . ,cₘ,e₀, . . . ,eₘεS_{L}, q₀, . . . qₘ,q′ₘεQ_{S}: path(q₀c₀q′₀e₀ . . . qₘcₘq′ₘeₘ, q_{S}, e*_{S}) ˆ q′ₘ=q*_{S} ˆ e_{L}≈e*_{S} ˆ [symbol] visited(e*_{S})}
   The minimum distance between the any e*_{S} of this set and the state q_{S} is called deviation for e_{L} from q_{S}: deviation(q_{S}, e_{L}), the corresponding elements (q*_{S}, e*_{S}) are called deviation targets for e_{L} from q_{S}: devTargets(qs, e_{L}). For example, FIG. 12C shows again our example automatons and the associated strategy transitions. Assuming that q_{S0} is the current state of the strategy automaton, all conditions evaluate to true, and none of the knowledge items has been visited so far, these are (q_{S1}, e_{S0}) for the transition candidate e_{L2} and (q_{S7}, e_{S5}) for the transition candidate e_{L1}. Since both terminate the shortest path for the corresponding transition candidate they are the deviation targets for (q_{S0}, e_{L2}) and (q_{S0}, e_{L1}) respectively and the deviation for (q_{S0}, e_{L2}) is 1 and for (q_{S0}, e_{L1}) it is 0.

Generally, method 900 computes the closest reachable transition in the strategy automaton 225 starting from a state q_{S} that corresponds with the given knowledge item and the deviation for this transition from q_{S}. The example technique follows the strategy automaton 225 starting from a state q_{S} and computes those transitions in the strategy automaton 225 that can be reached from that state and that correspond with the given knowledge item of the learning unit automaton 230. Illustrated method 900 begins at step 902, the deviation target is initialized and the deviation is initialized with any suitable value at step 904 such as, for example, the number of states of the strategy automaton. Next, the states of strategy template automaton 225 are marked “not checked” and “not to be checked” at step 906. At step 907, LMS 140 identifies or receives a given state of strategy automaton 225 and marks it “to be checked”. Based on a suitably determined initial marking in this example, then processing of the associated strategy transitions can be performed while there remain states to be processed (as shown by decisional step 908).

The first strategy state marked to be checked is selected at step 910. Then, at step 912, the selected state is marked “not to be checked” and “checked” to help ensure that it is not processed again. If there are any transitions starting from the selected state, as determined in step 913, a first transition starting from that state is then identified at step 914. LMS 140 then determines if the symbol of the identified transition corresponds to a given knowledge item of the learning automaton 230 at decisional step 914. If it does, then at step 918 LMS may compute the distance from the given strategy automaton state. If the computed distance is less than the current deviation (initialized to the number of items in the set) at decisional step 920, then the current distance is made the deviation at step 922 and the deviation target is set to the current transition at step 924. At decisional step 926, LMS 140 determines if the target state of the transition has not been processed before and if the transition is executable. If it is executable and has not been previously processed, then the target state is marked “to be checked” at step 928. Then processing returns to step 913, determining if there are more transitions to be processed. If there are, then the next transition is selected (or otherwise identified) at step 914. If there are no more transitions to be processed, then this example processing returns to step 906. Method 900 then selects that transition that has the minimal distance from the given strategy automaton state. Finally, it returns the selected transition target and the associated deviation at step 934. In certain embodiments, nil may returned as the deviation target and the number of states of the strategy automaton as deviation if no corresponding transition exists. For example, a similar process may be implemented following the pseudo code included below:

computeDeviationAndDevTarget(q_{S},e_{L}) {

devTarget := nil
deviation := |Q_{S}|
ToBeChecked := {q_{S}}
Checked := { }
while (ToBeChecked ≠ { }) {

q′_{S} :=select element of checkStates
ToBeChecked := ToBeChecked − {q′_{S}}
Checked := Checked + {q′_{S}}
for each (q′_{S},s_{S},q″_{S}) ∈ transitions(q′_{S}))} {

if (s_{S}∈E_{S} [symbol] s_{S}≈e_{L}) {

n := distance(q_{S},s_{S})
if (n < deviation) {

devTarget := (q′_{S},s_{S})
deviation := n

}

}
else if (q″_{S} ∉ Checked [symbol] (s_{S}∈C_{S} [symbol] eval(s_{S}))) {

ToBeChecked := ToBeChecked + {q″_{S}}

}

}

}
return (devTarget, deviation)

}

Of course, the foregoing pseudo code is for example purposes only and may not represent the programmatic, logic, or data flow implementing processes similar to that described in method 900 to determine the set of associated strategy items together with their distances starting from a given state of the strategy automaton and a knowledge item of the learning automation, as well as determining the deviation and deviation targets for that set.

According to some embodiments, learning management system 140 may incorporate certain considerations to assess the one or more learning strategies as described above in example methods 600-900. For example, the weighting function can be arbitrarily specified. In this way, different techniques can be exploited by the particular process. In another example, the assessment of the deviation of learning unit item order may not strictly correspond with the quality measure. In this case, the measure may work on complete sequences and thus cannot be broken down to local situations. In another example, the complexity (or maximal processing time) of the particular process may be linear in the number of states and transitions of the respective automatons. This example typically applies to the shortest path computations. Put another way, the overall process complexity may be O(|states in unit automaton|*max(|states and transitions in unit automaton|, |states and transitions in strategy automaton|). In a further example, the evaluation of conditions (the eval-function) may depend on the nature of the respective condition. Some conditions (for example visited attributes) can be evaluated depending on the previous sequencing through the respective automaton. Others, such as test results, may be evaluated by some suitable heuristics. For these example tests, learning management system 140 may assume that they are always passed. In another embodiment, tests may be considered special knowledge items. In this way, the result of a test could then influence the further navigation through the particular learning unit. Continuing this example, additional relation types (for passed and failed tests) could be added to the graphical representation of learning units 230 and strategy templates 225. These relationships can then be represented as special conditions within the respective conditional regular expressions. Indeed, the navigational support could be extended to reset the visited attributes of some items relevant for the scope of the test in case that a test was failed.

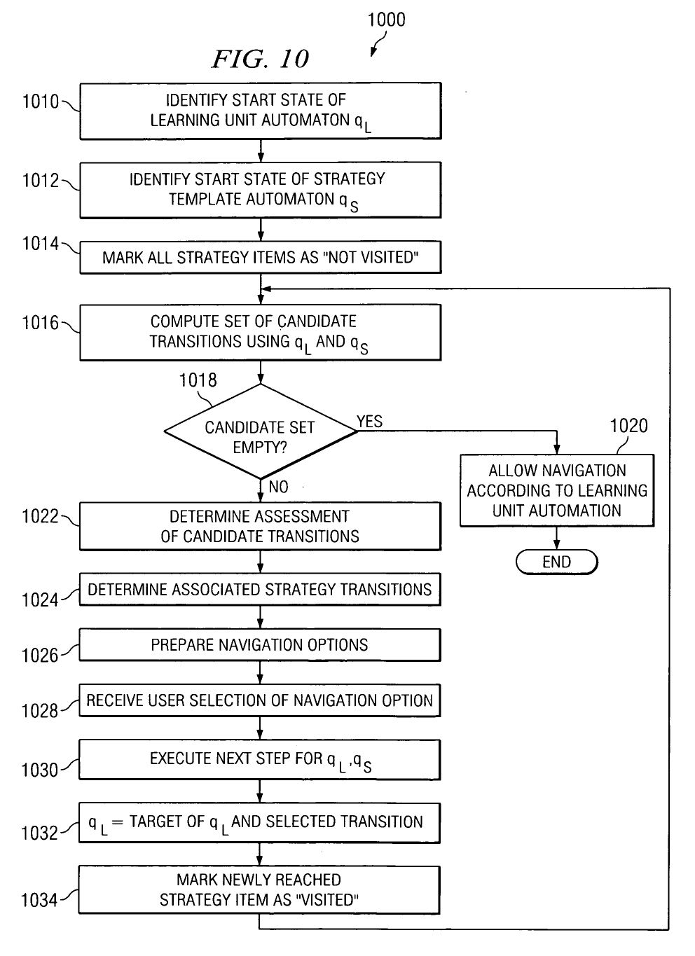

FIG. 10 is a flow chart illustrating an example method 1000 for providing navigation support based on user-managed learning strategies according to one embodiment of the present disclosure. Generally, the overall navigation support includes providing one or more options to learner 104. More specifically, at any point in time the user may get the option of being guided by the system—via content player 208 for example—by clicking on a “Next” button. In addition, the leaner may get several navigation options presented among which he has to make a choice. The navigation through the particular learning unit 230 is typically accompanied by the traversal of the associated learning unit and strategy template automatons 230 and 225. Thus, at any point in time, both automatons are within one specific state. Based on the current state of both automatons and a specified weighting function (or even a set of specified weighting functions), learning management system 140 can compute and assess the various navigation options. The optimal options may be associated with the guided navigation (Next button). Based on any suitable heuristic (such as best five or best of each weighting function), learning management system 140 may also present several navigation options for the learner's choice.

Once, a user has chosen a specific option, the system knows about its associated target state (in both automatons). It will then forward the unit automaton one step towards the specified target state. If (by this step) the target step is reached and there is also a specified target state for the strategy automaton, that automaton will be also set forward on that target state. In some cases, this underlies the restriction that none of the knowledge items on the strategy automaton's path is contained in the learning unit automaton and has not yet been visited.

For example, illustrated method 1000 chooses a candidate with the best assessment by first identifying the start states of the learning unit automaton 230 and strategy template automaton 225 at steps 1010 and 1012, respectively. At step 1014, the strategy items are marked as “not visited.” Using this set of not visited strategy items, LMS 140 may compute a set of candidate transitions at step 1016. Often concurrently with step 1014, LMS 140 may perform an assessment of the candidate transitions at step 1022 and may compute the associated strategy transitions at step 1026. As illustrated, LMS 140 may instead perform an assessment of the candidate transitions and compute the associated strategy transitions only if the candidate set is not empty as shown by decisional step 1018. In case of an empty set of candidate transitions, LMS 140 may allow navigation according to the learning unit automaton until a final state of the learning unit automaton is reached for the first time as illustrated at step 1020.

Once the assessments have been performed, LMS 140 then prepares navigation options at step 1026 and may present these options to the leaner 104. The system eventually receives a selection of a particular navigation option at step 1028. This selection of the navigation option may populate certain parameters including c′_{L} (containing the condition to reach the next knowledge item of the learning automaton), e′_{L} (containing the chosen knowledge item of the learning automaton), (q*_{L},e*_{L}) (containing the candidate transition aimed for), and (q*_{S},e*_{S}) (containing the associated deviation target). Next, method 1000 executes the next step for the particular learning unit automaton 230 and, eventually, the strategy template automaton at steps 1030 and 1032. This newly reached strategy item is marked as “visited” at step 1034 and processing returns to step 1016. For example, a process similar to that illustrated in FIG. 10 may be implemented by the following pseudo code:

q_{L} := i_{L}
q_{S} := i_{S}
notVisitedStrategyItems := S_{S}
loop {
(candidates, assessment[candidates], strategyCandidate[candidates])

:= assessment(q_{L}, q_{S}, notVisitedStrategyItems);

if (candidates = { }) {

allow navigation according to unit automaton till a final state is first reached
exit;

}
nextItem[candidates] := getFirstTransitionsOnPathToCandidates(candidates);
associateOptimalTargetWithNextNavigation(candidates,

assessment[candidates],
nextItem[candidates]);

optionallyPresentAdditionalNavigationTargets( );
(c′_{L}, e′_{L}, (q*_{L},e*_{L}), (q*_{S},e*_{S})) := waitForUserSelection(candidates,

strategyCandidates[candidates],
nextItem[candidates]);

q_{L} := target(q_{L}, c′_{L});
if ((q_{L},e′_{L})=(q*_{L},e*_{L}) [symbol] (q*_{S},e*_{S})!=nil) {

if (∃path(c₀,e₀,...,cₘ,eₘ, q_{S}, e*_{S})∀0≦i≦m: visited(eᵢ) [symbol] ∀e_{L}″∈S_{L}: [symbol] e″_{L}≈eᵢ)

q_{S} := target(q*_{S}, e*_{S})

}

q_{L}:=target(q_{L}, e′_{L});
adapt accordingly: notVisitedStrategyItems
   Of course, the foregoing pseudo code is for example purposes only and may not represent the programmatic, logic, or data flow implementing processes similar to that described in method 1000.

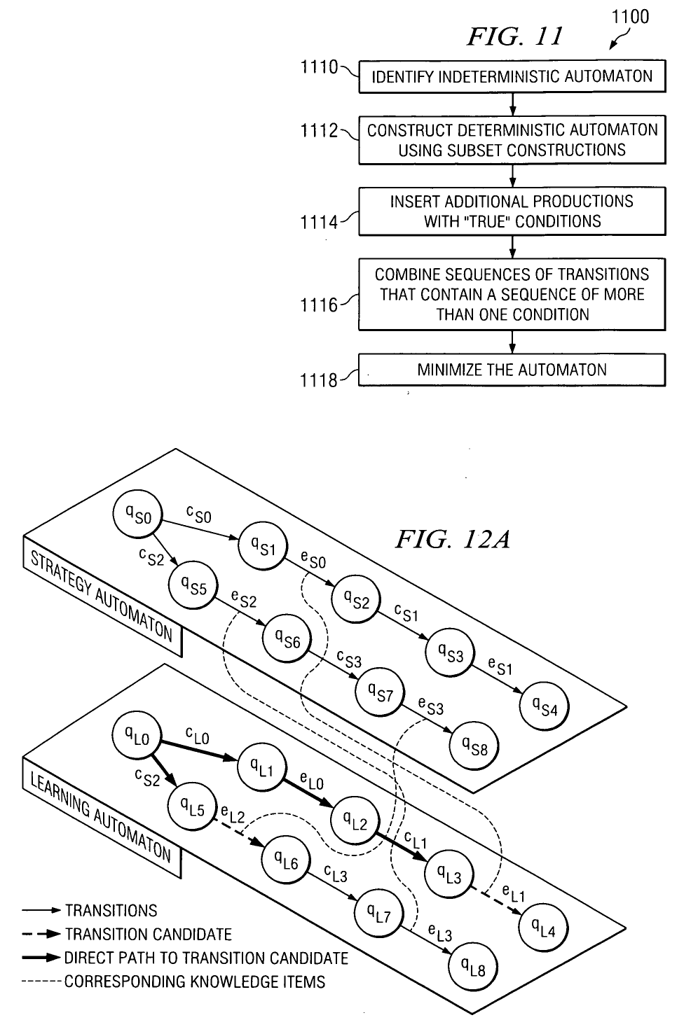

FIG. 11 is a flow chart illustrating an example method 1100 for deriving an automaton from a conditional regular expression according to one embodiment of the present disclosure. For purposes of this technique, let S be a finite set of symbols S={s₁,s₂, . . . ,sₙ}, sεS be an element of S and r₁, r₂ be conditional regular expressions and cεS a Boolean expression. Also, let A₁=(Q₁, S, P₁, i₁, f₁), A₂=(Q₂, S, P₂, i₂, f₂) be automatons that accept the regular expressions r₁, r₂ and, without loss of generality, assume that Q₁∩Q₂={}. Then, by the definition of regular expressions, any system can create the following automatons A* that will accept the corresponding regular expressions:

1. ε: A*=({i},S, {}, i, i)

2. s: A*=({i, f},S, {is::=f}, i, f)

3. r₁r₂: A*=(Q₁∪Q₂, S, P₁∪P₂∪{f₁::=i₂}, i₁, f2)

4. r₁|r₂: A*=(Q₁∪Q₂∪{i, f}, S, P₁∪P₂∪{i::=i₁, i::=i₂, f1::=f, f₂::=f}, i,f)

5. r₁* A*=(Q₁, S, P₁∪P₂∪{f₁::=i₁}, i₁, f₁)

6. c: r₁: A*=(Q₁∪{i}, S, P₁∪{ic::=i₁}, i, f₁)

The automaton constructed this way is normally indeterministic and not bipartite. But learning management system 140 may implement method 1100—or something similar—to generate a bipartite automaton.

Method 1100 begins at step 1110, where an indeterministic, non-bipartite automaton is identified. Next, at step 1112, learning management system constructs a deterministic automaton out of the indeterministic automaton by using a subset construction. For example, learning management system 140 may utilize the Myhill-Buchi algorithm or any other suitable technique. Normally, the resulting automaton does not have a single final state; it instead has a set of states that are final states. Learning management system 140 then inserts additional productions containing “true” conditions at step 1114. For example, for every state q₀ that has transitions q₀s::=q₁ where s is not a condition, it may insert the following additional transitions: q₀true::=q₀′, q₀′s::=q₁ where the second transition is inserted for transitions where s is not a condition. This generally results in an automaton where there are no two symbols s₀, s₁ and states q₀, q₁, q₂ such that q₀s₀::=q₁ and q₁s₁::=q₂ are in the set of the transitions of the automaton. In some situations, this also defines two disjoint sets Q₁, Q₂ of states with Q₁∪Q₂=Q, Q₁∩Q₂=Ø, as well as two disjoint sets E, C of symbols with E∪C=S, E∩C=Ø so that for each q₁εQ₁, q₂εQ₂, eεE, cεC the following condition holds: q₀e::=q₁εP→q₀c::=q₁εP. In these situations, conditions are in C and other symbols are in E.

At step 1116, learning management system 140 then combines sequences of transitions that contain a sequence of more than one condition by changing the condition to a composed condition. In other words, if there are two transitions q₀c₀::=q₁ and q₁c₁::=q₂, then replace it by a new transition q₀c₀ˆc₁::=q₂. This may be done recursively until there are no two transitions of this kind part of set of transitions the automaton. Then, at step 1118, learning management system 140 may determine congruent states in the resulting automaton to minimize the automaton. Typically, the resulting automaton is a bipartite automaton with the symbol set given by a set of conditions and a set of other symbols that are the disjoint. There may also be two set of states are disjoint by construction.

The preceding flowcharts and accompanying descriptions illustrate example methods 600, 700, 800, 900, 1000, and 1100. But environment 100 contemplates using any suitable technique for performing these and other tasks. Accordingly, many of the steps in these flowcharts may take place simultaneously and/or in different orders than as shown. Moreover, environment 100 may use methods with additional steps, fewer steps, and/or different steps, so long as the methods remain appropriate. For example, it will be understood that the client may execute portions of some of these processes described in these methods in parallel or in sequence as appropriate. In another example, the use of certain logical identifiers (such as “to be checked” or “not checked”) are for readability purposes only and any suitable processing, identification, or other categorization may be used. In a further example, instead of “removing” a particular item from its set to help reduce or eliminate duplicative processing, these methods may use any other appropriate technique, such as marking or using a pointer, to achieve the desired end.

A number of embodiments have been described. Nevertheless, it will be understood that various modifications may be made without departing from the scope of the disclosure. For example, while described herein as being implemented in a learning management system, the components and techniques may be used in any suitable similar or dissimilar application, module, or web service. Moreover, it is not required that the client and server reside within the same network, domain, or enterprise. In yet another example, some or all of the suitable described herein may be applied to arbitrarily structured courses, including structures at higher or lower levels, as well as complete course hierarchies.

What is claimed is:

1. A method for user management of learning strategies, comprising:
receiving a manipulation of a strategy graphical element via a graphical user interface;
incorporating the manipulation into a strategy template; and
providing navigation support of a learning unit based on the strategy template.

2. The method of claim 1, the strategy template comprising a plurality of strategy items, each strategy item corresponding to a graphical element operable to be presented via the GUI.

3. The method of claim 2, further comprising mapping the manipulation of the strategy graphical element to the strategy template.

4. The method of claim 2, further comprising presenting at least a subset of the graphical elements via the GUI.

5. The method of claim 2, the learning unit comprising a plurality of learning items, each learning item associated with a learning graphical element operable to be presented via the GUI.

6. The method of claim 5, further comprising identifying a learning strategy, based on the learning unit and the strategy template, for providing navigation support.

7. The method of claim 6, wherein the strategy template operable to be transformed into a bipartite finite strategy automaton with a plurality strategy items, the learning unit operable to be transformed into a bipartite finite learning automaton with a plurality of learning items, each learning item associated with a state, and the identification of the strategy comprises:
evaluating a set of potential strategy items from the strategy template; and
identifying an optional unit sequence of at least a portion of the potential strategy items.

8. The method of claim 1, further comprising creating the strategy template in response to the manipulation.

9. Software for user management of learning strategies, operable to:
receive a manipulation of a strategy graphical element via a graphical user interface;
incorporate the manipulation into a strategy template; and
provide navigation support of a learning unit based on the strategy template.

10. The software of claim 9, the strategy template comprising a plurality of strategy items, each strategy item corresponding to a graphical element operable to be presented via the GUI.

11. The software of claim 10, further operable to map the manipulation of the strategy graphical element to the strategy template.

12. The software of claim 10, further operable to present at least a subset of the graphical elements via the GUI.

13. The software of claim 10, the learning unit comprising a plurality of learning items, each learning item associated with a learning graphical element operable to be presented via the GUI.

14. The software of claim 13, further operable to identify a learning strategy, based on the learning unit and the strategy template, for providing navigation support.

15. The software of claim 14, wherein the strategy template operable to be transformed into a bipartite finite strategy automaton with a plurality strategy items, the learning unit operable to be transformed into a bipartite finite learning automaton with a plurality of learning items, each learning item associated with a state, and the identification of the strategy comprises the software further operable to:
evaluate a set of potential strategy items from the strategy template; and
identify an optional unit sequence of at least a portion of the potential strategy items.

16. The software of claim 9, further operable to create the strategy template in response to the manipulation.

17. A method for implementing a user-managed learning strategy comprising:
invoking a strategy template for a learning unit, the strategy template comprising a plurality of strategy items and the learning unit represented by a plurality of learning items;
identifying at least a portion of a learning strategy based on the strategy template and the learning unit; and
providing at least one navigation option to a learner, via a graphical user interface, based on the identified portion of the learning strategy.

18. The method of claim 17, the strategy template operable to be graphically manipulated by a user.

19. The method of claim 18, the user comprising the learner of the particular learning unit.

20. The method of claim 17, the identification of the learning strategy comprising:
identifying a current one of the strategy items, the current strategy item associated with a state;
identifying a current one of the learning item, the current learning item associated with a state;
assessing at least one candidate strategy item, each candidate strategy item comprising an unvisited item; and
determining at least one navigation option based on the assessed strategy items.

21. The method of claim 20, the assessment of at least one candidate strategy item comprising:
identifying strategy items that are reachable for a particular candidate and are not visited;
computing a target deviation and the deviation of the order of the identified strategy items; and
computing a weighted assessment value of the candidate.

22. The method of claim 17, further comprising:
receiving a selection of a particular one of the provided navigation options;
executing a step of the learning unit based on the selection; and
updating the state of the associated strategy item.

23. Software for implementing a user-managed learning strategy operable to:
invoke a strategy template for a learning unit, the strategy template comprising a plurality of strategy items and the learning unit represented by a plurality of learning items;
identify a learning strategy based on the strategy template and the learning unit; and
provide at least one navigation option to a learner, via a graphical user interface, based on the identified learning strategy.

24. The software of claim 23, the strategy template operable to be graphically manipulated by a user.

25. The software of claim 24, the user comprising the learner of the particular learning unit.

26. The software of claim 23, the identification of the learning strategy comprises the software operable to:
identify a current one of the strategy items, the current strategy item associated with a state;
identify a current one of the learning item, the current learning item associated with a state;
assess at least one candidate strategy item, each candidate strategy item comprising an unvisited item; and
determine at least one navigation option based on the assessed strategy items.

27. The software of claim 26, the assessment of at least one candidate strategy item comprises the software operable to:
identify strategy items that are reachable for a particular candidate and are not visited;
compute a target deviation and the deviation of the order of the identified strategy items; and
compute a weighted assessment value of the candidate.

28. The software of claim 23, further operable to:
receive a selection of a particular one of the provided navigation options;
execute a step of the learning unit based on the selection; and
update the state of the associated strategy item.
